(19) United States
(12) Patent Application Publication
(10) Pub. No.: US 2026/0172816 A1
(43) Pub. Date: Jun. 18, 2026

(54) USER EQUIPMENT, NETWORK ENTITY, NETWORK CLIENT AND METHODS FOR AUTOMATED RESOURCE ALLOCATION AND REPORTING CONDITIONED ON PERFORMANCE/CONSTRAINT REQUIREMENTS

(71) Applicant: FRAUNHOFER-GESELLSCHAFT ZUR FÖRDERUNG DER ANGEWANDTEN FORSCHUNG E.V., München (DE)

(72) Inventors: Georgios KONTES, Erlangen (DE); Mohammad ALAWIEH, Erlangen (DE); Birendra GHIMIRE, Erlangen (DE); Ernst EBERLEIN, Erlangen (DE); Christopher MUTSCHLER, Erlangen (DE)

(21) Appl. No.: 19/534,275

(22) Filed: Feb. 9, 2026

Related U.S. Application Data
(63) Continuation of application No. PCT/EP2024/072590, filed on Aug. 9, 2024.

(30) Foreign Application Priority Data
Aug. 10, 2023 (EP) 23190929.2

(51) Int. Cl. H04W 8/22; H04W 24/10

(52) U.S. Cl. CPC H04W 8/22; H04W 24/10

(57) ABSTRACT

A wireless communication system according to an embodiment comprising a network entity and a user equipment is provided. The network entity is configured for generating two or more configurations for another device of the wireless communication system, wherein the two or more configurations differ in at least one parameter. Moreover, the network entity is configured for transmitting the two or more configurations to another entity of the wireless communication system, for example, to a user equipment or, for example, to a base station. The two or more configurations are applicable for different environments of the other device and/or for different states of the other device and/or for different signal propagation conditions and/or for different properties of the other device.

### CROSS-REFERENCE TO RELATED APPLICATIONS

This application is a continuation of copending International Application No. PCT/EP2024/072590, filed Aug. 9, 2024, which is incorporated herein by reference in its entirety, and additionally claims priority from European Application No. EP 23190929.2, filed Aug. 10, 2023, which is also incorporated herein by reference in its entirety.

The present invention relates to wireless communication systems and, in particular, to a user equipment, a network entity, a network client and methods for automated resource allocation and reporting conditioned on performance/constraint requirements.

### BACKGROUND OF THE INVENTION

FIG. 7 is a schematic representation of an example of a terrestrial wireless network 500 including, as is shown in FIG. 7(a), the core network and one or more radio access networks RAN₁, RAN₂, . . . RAN_{N} (RAN=Radio Access Network). FIG. 7(b) is a schematic representation of an example of a radio access network RANₙ that may include one or more base stations gNB₁ to gNB₅ (gNB=next generation Node B), each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT (Internet of Things) devices which connect to a base station or to a user. The mobile devices or the IoT devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 7(b) shows an exemplary view of five cells, however, the RANₙ may include more or less such cells, and RANₙ may also include only one base station. FIG. 7(b) shows two users UE₁ and UE₂, (UE=User Equipment) also referred to as user equipment, UE, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 7(b) shows two IoT devices 110₁ and 110₂ in cell 106₄, which may be stationary or mobile devices. The IoT device 110₁ accesses the wireless communication system via the base station gNB₄ to receive and transmit data as schematically represented by arrow 1121. The IoT device 110₂ accesses the wireless communication system via the user UE₃ as is schematically represented by arrow 112₂. The respective base stations gNB₁ to gNB₅ may be connected to the core network 102, e.g. via the S1 interface, via respective backhaul links 114₁ to 114₅, which are schematically represented in FIG. 7(b) by the arrows pointing to “core”. The core network 102 may be connected to one or more external networks. The external network may be the Internet or a private network, such as an intranet or any other type of campus networks, e.g. a private WiFi or 4G or 5G mobile communication system. Further, some or all of the respective base stations gNB₁ to gNB₅ may be connected, e.g. via the S1 or X2 interface or the XN interface in NR (New Radio), with each other via respective backhaul links 116₁ to 116₅, which are schematically represented in FIG. 7(b) by the arrows pointing to “gNBs”. A sidelink channel allows direct communication between UEs, also referred to as device-to-device, D2D (Device to Device), communication. The sidelink interface in 3GPP (3G Partnership Project) is named PC5 (Proximity-based Communication 5).

For data transmission a physical resource grid may be used. The physical resource grid may comprise a set of resource elements to which various physical channels and physical signals are mapped. For example, the physical channels may include the physical downlink, uplink and sidelink shared channels, PDSCH (Physical Downlink Shared CHannel), PUSCH (Physical Uplink Shared Channel), PSSCH (Physical Sidelink Shared Channel), carrying user specific data, also referred to as downlink, uplink and sidelink payload data, the physical broadcast channel, PBCH (Physical Broadcast Channel), carrying for example a master information block, MIB, and one or more of a system information block, SIB, one or more sidelink information blocks, SLIBs, if supported, the physical downlink, uplink and sidelink control channels, PDCCH (Physical Downlink Control Channel), PUCCH (Physical Uplink Control CHannel), PSCCH (Physical Sidelink Control Channel), the downlink control information, DCI, the uplink control information, UCI, and the sidelink control information, SCI, and physical sidelink feedback channels, PSFCH (Physical sidelink feedback channel), carrying PC5 feedback responses. Note, the sidelink interface may support a 2-stage SCI (Speech Call Items). This refers to a first control region comprising some parts of the SCI, and, optionally, a second control region, which comprises a second part of control information.

For the uplink, the physical channels may further include the physical random-access channel, PRACH (Packet Random Access Channel) or RACH (Random Access Channel), used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g. 1 ms. Each subframe may include one or more slots of 12 or 14 OFDM symbols (OFDM=Orthogonal Frequency-Division Multiplexing) depending on the cyclic prefix, CP, length. A frame may also include of a smaller number of OFDM symbols, e.g. when utilizing a shortened transmission time interval, sTTI (slot or subslot transmission time interval), or a mini-slot/non-slot-based frame structure comprising just a few OFDM symbols.

The wireless communication system may be any single-tone or multicarrier system using frequency-division multiplexing, like orthogonal frequency-division multiplexing, OFDM, or orthogonal frequency-division multiple access, OFDMA (Orthogonal frequency-division multiple access), or any other IFFT-based signal (IFFT=Inverse Fast Fourier Transformation) with or without CP, e.g. DFT-s-OFDM (DFT=discrete Fourier transform). Other waveforms, like non-orthogonal waveforms for multiple access, e.g. filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 7 may be a heterogeneous network having distinct overlaid networks, e.g., a network of macro cells with each macro cell including a macro base station, like base stations gNB₁ to gNB₅, and a network of small cell base stations, not shown in FIG. 7, like femto or pico base stations. In addition to the above described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 7, for example in accordance with the LTE-Advanced Pro standard or the 5G or NR, new radio, standard.

In mobile communication networks, for example in a network like that described above with reference to FIG. 7, like an LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, or roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

In a wireless communication network, like the one depicted in FIG. 7, it may be desired to locate a UE with a certain accuracy, e.g., determine a position of the UE in a cell. Several positioning approaches are known, like satellite-based positioning approaches, e.g., autonomous and assisted global navigation satellite systems, A-GNSS, such as GPS, mobile radio cellular positioning approaches, e.g., observed time difference of arrival, OTDOA, and enhanced cell ID, E-CID, or combinations thereof.

In the context of 5G Framework for 3GPP AI/ML functionalities (AI: artificial intelligence; ML: machine-learning) will be identified, managed, and utilized for UE-side models and UE-part of two-sided models.

Some terms and functionalities are explained:

AI/ML functionality identification relates to using the existing communication 3GPP framework of Features as a starting point for discussions about AI/ML functionalities. The UE will indicate its supported functionalities or functionality for a given sub-use-case. The capabilities reported by the UE serve as a starting point for AI/ML model identification.

Considering AI/ML Model Identification, models are identified at the Network. The Network will assign model IDs to AI/ML models. The UE will indicate the AI/ML models it supports based on these model IDs.

Regarding, functionality-based Life Cycle Management (LCM), activation, deactivation, fallback, and switching of AI/ML functionality is conducted. The Network will control the activation, deactivation, fallback, or switching of AI/ML functionalities through 3GPP signaling (e.g., RRC-Radio Resource Control, MAC-CE-MAC Control Element, DCI-Downlink Control Information).

In UE-level Model Life Cycle Management, models may not be specifically identified at the network, and the UE may manage the life cycle of individual AI/ML models on its own.

Regarding Model-ID-based Life Cycle Management (LCM), models are identified at the network. In this approach, AI/ML models are specifically identified at the Network, and each model is associated with a unique model ID.

Regarding activation, deactivation, selection and switching of AI/ML models, both the network and the UE may activate, deactivate, select, or switch individual AI/ML models using the respective model IDs.

The term functionality may, e.g., refers to an AI/ML-enabled feature or function group (FG) that can be enabled through specific configurations, which are supported based on conditions indicated by the UE capability.

Functionality-Based LCM operates based on at least one configuration of an AI/ML-enabled feature/FG (feature group) or specific configurations of it.

Some explanations are provided to support functionality-based LCM operations, such as activating, deactivating, falling back to, or switching AI/ML functionalities.

Regarding AI/ML model identification and Model-ID-based LCM, in Model-ID-based LCM operations are conducted based on identified models, where each model may be associated with specific configurations/conditions related to UE capability of an AI/ML-enabled Feature/FG and additional conditions determined between a UE-side and a network (NW)-side.

FIG. 2 illustrates the Life Cycle Management (LCM) process as defined within 3GPP.

This current 3GPP framework assumes a static process: The NW and the UE coordinate on a functionality to be applied from all the possible supported functionalities. A functionality is defined by a specific configuration that for example supports a specific combination of Set A/Set B beams for beam management or requests measurements from specific TRPs for positioning. If the radio environment conditions change (e.g., different SNR levels, Doppler/UE speed, blockage of TRPs, etc.), most likely a different functionality needs to be negotiated/coordinated between the NW and the UE, configured, and applied.

### SUMMARY

An embodiment may have a network entity of a wireless communication system, wherein the network entity is configured for generating two or more configurations for another device of the wireless communication system, wherein the two or more configurations differ in at least one parameter; and transmitting the two or more configurations to another entity of the wireless communication system, for example, to a user equipment or, for example, to a base station, wherein the two or more configurations are applicable for different environments of the other device and/or for different states of the other device and/or for different signal propagation conditions and/or for different properties of the other device.

Another embodiment may have a network entity of a wireless communication system, wherein the network entity is configured for receiving a target (e.g., a performance target), requesting and/or receiving information and/or identifying configurations for necessary resources and/or measurement and/or reporting depending on the target, determining at least one resource and/or measurement and/or report configuration to achieve the target, enabling or activating an artificial intelligence/machine-learning model using the configured resources and using received reporting to perform a task (e.g., beam management or positioning); and/or receiving a constraint limit on one or more available resources, predicting a maximum performance (e.g., positioning accuracy) that is achievable, selecting and configuring resources and/or selecting a reporting complexity to achieve the maximum performance, enabling or activating an artificial intelligence/machine-learning model using the configured resources and using a received reporting to perform a task (e.g., to predict a position of a UE).

Another embodiment may have a user equipment of a wireless communication system, wherein the user equipment is configured for receiving, from a network entity of the wireless communication system, two or more configurations, wherein the two or more configurations differ in at least one parameter; wherein the two or more configurations are applicable for different environments of the user equipment and/or for different states of the user equipment and/or for different signal propagation conditions and/or for different properties of the user equipment, selecting one of the two or more configurations depending on a current environment of the user equipment and/or depending on a current state of the user equipment and/or depending on a current signal propagation condition and/or depending on a property of the user equipment; applying said one of the two or more configurations at the user equipment, for example for transmitting or receiving a reference signal and/or for measuring and/or reporting on a reference signal.

Another embodiment may have a user equipment of a wireless communication system, wherein the user equipment is configured for selecting one of two or more configurations depending on a current environment of the user equipment and/or depending on a current state of the user equipment and/or depending on a property of the user equipment; wherein the two or more configurations differ in at least one parameter; wherein the two or more configurations are applicable for different environments of the user equipment and/or for different states of the other user equipment and/or for different signal propagation conditions and/or for different properties of the user equipment; and applying said one of the two or more configurations at the user equipment, for example for transmitting or receiving a reference signal and/or for measuring and/or reporting on a reference signal; wherein the user equipment is configured to select and apply said one of the two or more configurations for machine-learning data collection and/or for machine-learning model monitoring.

Another embodiment may have a network client, wherein the network client is configured for transmitting information on a target or transmit a request to network entity of a wireless communication system, wherein a reception of the information on the target or a reception of the request by the network entity causes the network entity to generate two or more configurations for another device of the wireless communication system.

According to another embodiment, a wireless communication system may have:
a network entity of a wireless communication system, wherein the network entity is configured for generating two or more configurations for another device of the wireless communication system, wherein the two or more configurations differ in at least one parameter; and transmitting the two or more configurations to another entity of the wireless communication system, for example, to a user equipment or, for example, to a base station, wherein the two or more configurations are applicable for different environments of the other device and/or for different states of the other device and/or for different signal propagation conditions and/or for different properties of the other device, and
a user equipment of a wireless communication system, wherein the user equipment is configured for selecting one of two or more configurations depending on a current environment of the user equipment and/or depending on a current state of the user equipment and/or depending on a property of the user equipment; wherein the two or more configurations differ in at least one parameter; wherein the two or more configurations are applicable for different environments of the user equipment and/or for different states of the other user equipment and/or for different signal propagation conditions and/or for different properties of the user equipment; and applying said one of the two or more configurations at the user equipment, for example for transmitting or receiving a reference signal and/or for measuring and/or reporting on a reference signal; wherein the user equipment is configured to select and apply said one of the two or more configurations for machine-learning data collection and/or for machine-learning model monitoring.

According to another embodiment, a wireless communication system may have:
a network entity a network entity of a wireless communication system, wherein the network entity is configured for generating two or more configurations for another device of the wireless communication system, wherein the two or more configurations differ in at least one parameter; and transmitting the two or more configurations to another entity of the wireless communication system, for example, to a user equipment or, for example, to a base station, wherein the two or more configurations are applicable for different environments of the other device and/or for different states of the other device and/or for different signal propagation conditions and/or for different properties of the other device, and
an inventive network client.

According to another embodiment, a method for a wireless communication system may have the steps of: generating, by a network entity of the wireless communication system, two or more configurations for another device of the wireless communication system, wherein the two or more configurations differ in at least one parameter; and transmitting, by the network entity, the two or more configurations to another entity of the wireless communication system, for example, to a user equipment or, for example, to a base station, wherein the two or more configurations are applicable for different environments of the other device and/or for different states of the other device and/or for different signal propagation conditions and/or for different properties of the other device.

According to another embodiment, a method for a wireless communication system may have the steps of: receiving a target (e.g., a performance target), requesting and/or receiving information and/or identifying configurations for necessary resources and/or measurement and/or reporting depending on the target, determining at least one resource and/or measurement and/or report configuration to achieve the target, enabling or activating an artificial intelligence/machine-learning model using the configured resources and using received reporting to perform a task (e.g., beam management or positioning); and/or receiving, by a network entity of the wireless communication system, a constraint limit on one or more available resources, predicting, by the network entity, a maximum performance (e.g., positioning accuracy) that is achievable, selecting and configuring, by the network entity, resources, and/or selecting a reporting complexity to achieve the maximum performance, enabling or activating, by the network entity, an artificial intelligence/machine-learning model using the configured resources and using a received reporting to perform a task (e.g., to predict a position of a UE).

According to another embodiment, a method for a wireless communication system may have the steps of: receiving, by a user equipment of the wireless communication system from a network entity of the wireless communication system, two or more configurations, wherein the two or more configurations differ in at least one parameter; wherein the two or more configurations are applicable for different environments of the user equipment and/or for different states of the user equipment and/or for different signal propagation conditions and/or for different properties of the user equipment, selecting, by the user equipment, one of the two or more configurations depending on a current environment of the user equipment and/or depending on a current state of the user equipment and/or depending on a current signal propagation condition and/or depending on a property of the user equipment; and applying, by the user equipment, said one of the two or more configurations at the user equipment, for example for transmitting or receiving a reference signal and/or for measuring and/or reporting on a reference signal.

According to another embodiment, a method for a wireless communication system may have the steps of: selecting, by a user equipment, one of two or more configurations depending on a current environment of the user equipment and/or depending on a current state of the user equipment and/or depending on a current different signal propagation condition depending on a property of the user equipment; wherein the two or more configurations differ in at least one parameter; wherein the two or more configurations are applicable for different environments of the user equipment and/or for different states of the user equipment and/or for different properties of the user equipment; and applying, by the user equipment, said one of the two or more configurations at the user equipment, for example for transmitting or receiving a reference signal and/or for measuring and/or reporting on a reference signal; wherein the user equipment selects and applies said one of the two or more configurations for machine-learning data collection and/or for machine-learning model monitoring.

According to another embodiment, a method for a wireless communication system may have the steps of: transmitting, by a network client, information on a target or transmit a request to network entity of a wireless communication system, wherein a reception of the information on the target or a reception of the request by the network entity causes the network entity to generate two or more configurations for another device of the wireless communication system.

Another embodiment may have a non-transitory digital storage medium having a computer program stored thereon to perform any of the inventive methods when said computer program is run by a computer.

A network entity of a wireless communication system according to an embodiment is provided. The network entity is configured for generating two or more configurations for another device of the wireless communication system, wherein the two or more configurations differ in at least one parameter. Moreover, the network entity is configured for transmitting the two or more configurations to another entity of the wireless communication system, for example, to a user equipment or, for example, to a base station. The two or more configurations are applicable for different environments of the other device and/or for different states of the other device and/or for different signal propagation conditions and/or for different properties of the other device.

Moreover, a network entity of a wireless communication system according to an embodiment is provided. The network entity is configured for receiving a target (e.g., a performance target), requesting and/or receiving information and/or identifying configurations for necessary resources and/or measurement and/or reporting depending on the target, determining at least one resource and/or measurement and/or report configuration to achieve the target, and enabling or activating an artificial intelligence/machine-learning model using the configured resources and using received reporting to perform a task (e.g., beam management or positioning). And/or, the network entity is configured for receiving a constraint limit on one or more available resources, predicting a maximum performance (e.g., positioning accuracy) that is achievable, selecting and configuring resources and/or selecting a reporting complexity to achieve the maximum performance, and enabling or activating an artificial intelligence/machine-learning model using the configured resources and using a received reporting to perform a task (e.g., to predict a position of a UE).

Furthermore, a user equipment of a wireless communication system according to an embodiment is provided. The user equipment is configured for receiving, from a network entity of the wireless communication system, two or more configurations, wherein the two or more configurations differ in at least one parameter; wherein the two or more configurations are applicable for different environments of the user equipment and/or for different states of the user equipment and/or for different signal propagation conditions and/or for different properties of the user equipment. Moreover, the user equipment is configured for selecting one of the two or more configurations depending on a current environment of the user equipment and/or depending on a current state of the user equipment and/or depending on a current signal propagation condition and/or depending on a property of the user equipment. Furthermore, the user equipment is configured for applying said one of the two or more configurations at the user equipment, for example for transmitting or receiving a reference signal and/or for measuring and/or reporting on a reference signal.

Moreover, a user equipment of a wireless communication system according to an embodiment is provided. The user equipment is configured for selecting one of two or more configurations depending on a current environment of the user equipment and/or depending on a current state of the user equipment and/or depending on a property of the user equipment; wherein the two or more configurations differ in at least one parameter; wherein the two or more configurations are applicable for different environments of the user equipment and/or for different states of the other user equipment and/or for different signal propagation conditions and/or for different properties of the user equipment. Furthermore, the user equipment is configured for applying said one of the two or more configurations at the user equipment, for example for transmitting or receiving a reference signal and/or for measuring and/or reporting on a reference signal. The user equipment is configured to select and apply said one of the two or more configurations for machine-learning data collection and/or for machine-learning model monitoring.

Furthermore, a network client according to an embodiment is provided. The network client is configured for transmitting information on a target or transmit a request to network entity of a wireless communication system, wherein a reception of the information on the target or a reception of the request by the network entity causes the network entity to generate two or more configurations for another device of the wireless communication system.

Moreover, a wireless communication system according to an embodiment comprising a network entity and a user equipment is provided. The network entity is configured for generating two or more configurations for another device of the wireless communication system, wherein the two or more configurations differ in at least one parameter. Moreover, the network entity is configured for transmitting the two or more configurations to another entity of the wireless communication system, for example, to a user equipment or, for example, to a base station. The two or more configurations are applicable for different environments of the other device and/or for different states of the other device and/or for different signal propagation conditions and/or for different properties of the other device. The user equipment is configured for receiving, from the network entity, the two or more configurations and for selecting one of the two or more configurations depending on a current environment of the user equipment and/or depending on a current state of the user equipment and/or depending on a current signal propagation condition and/or depending on a property of the user equipment. Furthermore, the user equipment is configured for applying said one of the two or more configurations at the user equipment, for example for transmitting or receiving a reference signal and/or for measuring and/or reporting on a reference signal.

Furthermore, a method for a wireless communication system according to an embodiment is provided. The method comprises:
Generating, by a network entity of the wireless communication system, two or more configurations for another device of the wireless communication system, wherein the two or more configurations differ in at least one parameter. And:
Transmitting, by the network entity, the two or more configurations to another entity of the wireless communication system, for example, to a user equipment or, for example, to a base station.

The two or more configurations are applicable for different environments of the other device and/or for different states of the other device and/or for different signal propagation conditions and/or for different properties of the other device.

Moreover, a method for a wireless communication system according to an embodiment is provided. The method comprises:
Receiving a target (e.g., a performance target),
Requesting and/or receiving information and/or identifying configurations for necessary resources and/or measurement and/or reporting depending on the target,
Determining at least one resource and/or measurement and/or report configuration to achieve the target,
Enabling or activating an artificial intelligence/machine-learning model using the configured resources and using received reporting to perform a task (e.g., beam management or positioning);

### And/or:

Receiving, by a network entity of the wireless communication system, a constraint limit on one or more available resources,
Predicting, by the network entity, a maximum performance (e.g., positioning accuracy) that is achievable,
Selecting and configuring, by the network entity, resources, and/or selecting a reporting complexity to achieve the maximum performance,
Enabling or activating, by the network entity, an artificial intelligence/machine-learning model using the configured resources and using a received reporting to perform a task (e.g., to predict a position of a UE).

Furthermore, a method for a wireless communication system according to an embodiment is provided. The method comprises:
Receiving, by a user equipment of the wireless communication system from a network entity of the wireless communication system, two or more configurations, wherein the two or more configurations differ in at least one parameter; wherein the two or more configurations are applicable for different environments of the user equipment and/or for different states of the user equipment and/or for different signal propagation conditions and/or for different properties of the user equipment.
Selecting, by the user equipment, one of the two or more configurations depending on a current environment of the user equipment and/or depending on a current state of the user equipment and/or depending on a current signal propagation condition and/or depending on a property of the user equipment. And:
Applying, by the user equipment, said one of the two or more configurations at the user equipment, for example for transmitting or receiving a reference signal and/or for measuring and/or reporting on a reference signal.

Moreover, a method for a wireless communication system according to an embodiment is provided. The method comprises:
Selecting, by a user equipment, one of two or more configurations depending on a current environment of the user equipment and/or depending on a current state of the user equipment and/or depending on a current different signal propagation condition depending on a property of the user equipment; wherein the two or more configurations differ in at least one parameter; wherein the two or more configurations are applicable for different environments of the user equipment and/or for different states of the user equipment and/or for different properties of the user equipment. And:
Applying, by the user equipment, said one of the two or more configurations at the user equipment, for example for transmitting or receiving a reference signal and/or for measuring and/or reporting on a reference signal.

The user equipment selects and applies said one of the two or more configurations for machine-learning data collection and/or for machine-learning model monitoring.

Furthermore, a method for a wireless communication system according to an embodiment is provided. The method comprises transmitting, by a network client, information on a target or transmit a request to network entity of a wireless communication system, wherein a reception of the information on the target or a reception of the request by the network entity causes the network entity to generate two or more configurations for another device of the wireless communication system.

Moreover, computer programs are provided, wherein each of the computer programs is configured to implement one of the above-described methods when being executed on a computer or signal processor.

According to embodiments, a dynamic configuration mechanism (e.g., a dynamic functionality selection/activation/deactivation/switching) is provided, which would implement or activate the configuration in a flexible and adaptive manner, allowing the device (e.g., a UE) to apply it in real-time or as needed. Instead of statically setting the configuration parameters, the dynamic framework allows for adjustments so that device applies the configuration dynamically based on certain conditions, variables, or changes in the environment. This approach allows for on-the-fly adjustments and optimization of the configuration to suit the current requirements or circumstances.

### BRIEF DESCRIPTION OF THE DRAWINGS

Embodiments of the present invention will be detailed subsequently referring to the appended drawings, in which:

FIG. 1 illustrates a wireless communication system according to an embodiment.

FIG. 2 illustrates the Life Cycle Management (LCM) process as defined within 3GPP.

FIG. 3 illustrates on its left side a positioning example and on its right side beam management with a hierarchical codebook.

FIG. 4 illustrates an event/configuration association according to an embodiment.

FIG. 5 illustrates a positioning dynamic configuration according to an embodiment.

FIG. 6 illustrates a communication flow chart in a wireless communication system according to an embodiment.

FIG. 7 illustrates a schematic representation of an example of a terrestrial wireless network.

FIG. 8 illustrates an example of a computer system on which units or modules as well as the steps of the methods described in accordance with the inventive approach may execute.

### DETAILED DESCRIPTION OF THE INVENTION

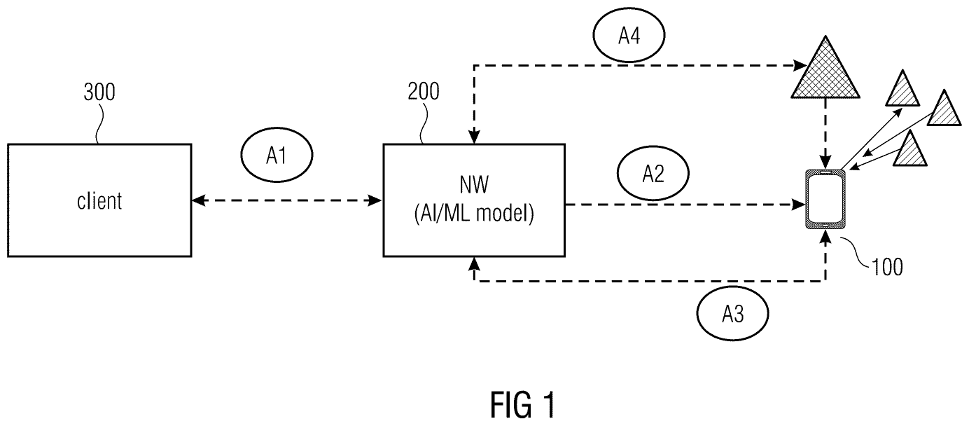

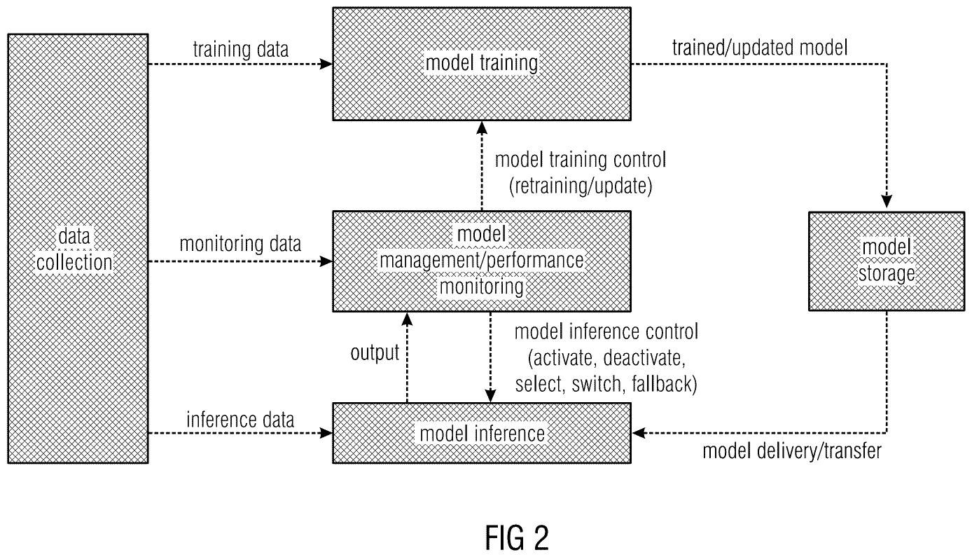

FIG. 1 illustrates a wireless communication system according to an embodiment. In particular, a network client 300 according to an embodiment, a network entity 200 according to an embodiment and a user equipment 100 according to an embodiment is provided.

The further details of FIG. 1 described below represent specific examples of particular embodiments.

A network entity 200 of a wireless communication system according to an embodiment is provided. The network entity 200 is configured for generating two or more configurations for another device of the wireless communication system, wherein the two or more configurations differ in at least one parameter. Moreover, the network entity 200 is configured for transmitting the two or more configurations to another entity of the wireless communication system, for example, to a user equipment 100 or, for example, to a base station. The two or more configurations are applicable for different environments of the other device and/or for different states of the other device and/or for different signal propagation conditions and/or for different properties of the other device.

According to an embodiment, the two or more configurations are applicable for machine-learning data collection and/or for machine-learning model monitoring.

In an embodiment, the network entity 200 is configured to generate the two or more configurations by enabling or activating an artificial intelligence/machine-learning model, e.g., depending on a Life Cycle Management process.

According to an embodiment, the network entity 200 may, e.g., be configured to generate the two or more configurations by enabling or activating the artificial intelligence/machine-learning model, e.g., depending on a Life Cycle Management process. The network entity 200 may, e.g., be configured to feed input information into the artificial intelligence/machine-learning model, to obtain an output of the artificial intelligence/machine-learning model. In response to receiving the input information, the artificial intelligence/machine-learning model may, e.g., be configured to output at least one of the two or more configurations as the output of the artificial intelligence/machine-learning model. Or, in response to receiving the input information, the artificial intelligence/machine-learning model may, e.g., be configured to output an intermediate output as the output of the artificial intelligence/machine-learning model; and the network entity 200 may, e.g., be configured to generate at least one of the two or more configurations using the intermediate output.

In an embodiment, the network entity 200 may, e.g., be configured to receive from the other entity data for the artificial intelligence/machine-learning model.

Moreover, a network entity 200 of a wireless communication system according to an embodiment is provided. The network entity 200 is configured for receiving a target (e.g., a performance target), requesting and/or receiving information and/or identifying configurations for necessary resources and/or measurement and/or reporting depending on the target, determining at least one resource and/or measurement and/or report configuration to achieve the target, and enabling or activating an artificial intelligence/machine-learning model using the configured resources and using received reporting to perform a task (e.g., beam management or positioning). And/or, the network entity 200 is configured for receiving a constraint limit on one or more available resources, predicting a maximum performance (e.g., positioning accuracy) that is achievable, selecting and configuring resources and/or selecting a reporting complexity to achieve the maximum performance, and enabling or activating an artificial intelligence/machine-learning model using the configured resources and using a received reporting to perform a task (e.g., to predict a position of a UE).

According to an embodiment, the network entity 200 may, e.g., be configured to provide information on the at least one resource and/or on the at least one measurement and/or on the at least one report configuration, which has been determined by the network entity 200 to achieve the target, to a user equipment 100 and/or to a TRP.

In an embodiment, the network entity 200 may, e.g., be configured to receive from another entity of the wireless communication system data for the artificial intelligence/machine-learning model.

According to an embodiment, the data for the artificial intelligence/machine-learning model may, e.g., be measurement data or reporting data.

In an embodiment, the network entity 200 may, e.g., comprise the artificial intelligence/machine-learning model.

According to an embodiment, the artificial intelligence/machine-learning model may, e.g., be distributed over two or more devices.

In an embodiment, the artificial intelligence/machine-learning model may, e.g., be a neural network.

According to an embodiment, the network entity 200 may, e.g., be configured to receive training or validation data for the artificial intelligence/machine-learning model and ground truth labels; and wherein the network entity 200 may, e.g., be configured to train and/or to validate the artificial intelligence/machine-learning model using the training or validation data and the ground truth labels.

In an embodiment, the network entity 200 may, e.g., be configured to employ data augmentation using two or more algorithms on a same data set for training the artificial intelligence/machine-learning model.

According to an embodiment, the network entity 200 may, e.g., be configured to train the artificial intelligence/machine-learning model depending on a performance condition and/or depending on a constraint condition.

In an embodiment, the network entity 200 may, e.g., be configured to request further training or validation data for training or validating the artificial intelligence/machine-learning model from the other device. The network entity 200 may, e.g., be configured to receive the further training or validation data from the other device. Mover, the network entity 200 may, e.g., be configured to train or to validate the artificial intelligence/machine-learning model using the training or validation data.

According to an embodiment, the network entity 200 may, e.g., comprise a monitoring entity for evaluating a performance of the artificial intelligence/machine-learning model.

In an embodiment, the artificial intelligence/machine-learning model may, e.g., be trained using supervised learning.

According to an embodiment, the artificial intelligence/machine-learning model may, e.g., be compiled and/or compressed for a target device.

In an embodiment, the artificial intelligence/machine-learning model, being compiled and/or compressed, may, e.g., be transmitted to the target device.

According to an embodiment, the network entity 200 may, e.g., be configured to receive the environment information and/or the properties information and/or the capabilities information and/or the Life Cycle Management information. Or, the network entity 200 may, e.g., be configured to generate the input information depending on the environment information and/or the properties information and/or the capabilities information and/or the Life Cycle Management information.

In an embodiment, the network entity 200 may, e.g., be configured for generating two or more configurations for another device of the wireless communication system, wherein the two or more configurations differ in at least one parameter; and for transmitting the two or more configurations to another entity of the wireless communication system, for example, to a user equipment 100 or, for example, to a base station. The two or more configurations are applicable for different environments of the other device and/or for different states of the other device and/or for different signal propagation conditions and/or for different properties of the other device.

According to an embodiment, the network entity 200 may, e.g., be configured to generate the two or more configurations depending on a target and/or depending on a request.

In an embodiment, the target may, e.g., comprise a performance target, and wherein the network entity 200 may, e.g., be configured to generate the two or more configurations depending on the performance target.

According to an embodiment, the target may, e.g., comprise a quality-of service, and wherein the network entity 200 may, e.g., be configured to generate the two or more configurations depending on the quality-of-service.

In an embodiment, the request may, e.g., comprise a request for a service, and wherein the network entity 200 may, e.g., be configured to generate the two or more configurations depending on the request for the service.

According to an embodiment, the network entity 200 may, e.g., be configured to receive the request and/or the information on the target from a network client 300.

In an embodiment, the network entity 200 may, e.g., be configured to repeatedly receive requests from the network client 300 and/or to repeatedly receive the information on the target from the network client 300. The network entity 200 may, e.g., be configured to update at least one of the two or more configurations or to newly generate at least one of the two or more configurations depending on a change of the requests and/or depending on a change of the target.

According to an embodiment, the network client 300 may, e.g., be different from the other device for which the network entity 200 may, e.g., be configured to generate the two or more configurations.

In an embodiment, the network client 300 may, e.g., be the other device for which the network entity 200 may, e.g., be configured to generate the two or more configurations.

According to an embodiment, the network entity 200 may, e.g., be configured to receive environment information and/or properties information and/or capabilities information and/or

Life Cycle Management information from the other device. The network entity 200 may, e.g., be configured to generate the two or more configurations depending on the environment information and/or depending on the properties information and/or depending on the capabilities information and/or depending on Life Cycle Management information. The environment information depends on a current environment where the other device may, e.g., be currently located. The properties information indicates on one or more current properties of the other device. The capabilities information indicates one or more general or current capabilities of the other device. The Life Cycle Management information indicates information on Life Cycle Management of the other device.

In an embodiment, the network entity 200 may, e.g., be configured to repeatedly receive the environment information and/or the properties information and/or the capabilities information and/or the Life Cycle Management information from the other device. The network entity 200 may, e.g., be configured to update the two or more configurations or to generate newly generate the two or more configurations depending on a change of the environment information and/or the properties information and/or the capabilities information and/or the Life Cycle Management information from the other device.

According to an embodiment, the two or more configurations are provided together with side information for supporting to determine under which circumstances which of the two or more configurations may, e.g., be applicable.

In an embodiment, the other device may, e.g., be a user equipment 100.

According to an embodiment, the two or more configurations are applicable for different channel states depending on line-of-sight conditions of the user equipment 100 to one or more base stations, and/or are applicable for different transmission and/or reception qualities, and/or are applicable for different battery states of the user equipment 100.

In an embodiment, the two or more configurations are applicable for different measurement properties.

According to an embodiment, the two or more configurations are applicable for different power related average powers, such as RSRP and/or SINR, and/or are applicable for different path powers, such RSRPP, and/or are applicable for different timings (ToA), and/or are applicable for different timing differences between two or more resources, and/or are applicable for different angular or directional information.

In an embodiment, the other device may, e.g., be a base station.

According to an embodiment, one of the two or more configurations may, e.g., comprise a default configuration or may, e.g., comprise a fallback configuration, which may, e.g., be applicable by default, if none of all other configurations of the two or more configurations may, e.g., be applicable.

In an embodiment, the two or more configurations comprise two or more measurement configurations.

According to an embodiment, at least one of the two or more measurement configurations may, e.g., be applicable for a DL or SL resource measurement at a TRP.

In an embodiment, at least one of the two or more measurement configurations may, e.g., comprise certainty information or potential relevant or detectable resources. And/or, at least one of the two or more measurement configurations may, e.g., comprise information to enable the other device to derive necessary/desired information, e.g., detection threshold information, resources group association. And/or, at least one of the two or more measurement configurations may, e.g., comprise measurement procedures, which instruct or assist the device identify a set of relevant resources, e.g., depending on one or more initial measurements.

According to an embodiment, the two or more configurations comprise two or more report configurations.

In an embodiment, at least one of the two or more report configurations may, e.g., be applicable for a DL or SL resource derived from a channel measurement at a UE or an UL derived from a channel measurement at a TRP.

According to an embodiment, at least one of the two or more report configurations may, e.g., be dependent on the environment and measurement characteristics, wherein the UE/TRP selects the dynamic configuration based on a given event. And/or, at least one of the two or more report configurations may, e.g., be applicable at the inference device where the AI/ML inference model may, e.g., be installed or to a device or monitoring information to as second entity/device which can be a network entity 200 or in the case of two or multiple sided AI/ML models.

In an embodiment, the two or more configurations comprise two or more transmission configurations.

According to an embodiment, at least one of the two or more transmission configurations may, e.g., be applicable for UL at a UE or for DL resources at a TRP.

In an embodiment, at least one of the two or more transmission configurations depends on a QoS and/or depends on particular environmental conditions and/or depends on characteristics of a received signal.

According to an embodiment, at least one of the two or more transmission configurations comprise at least one of
a time resource allocation and a frequency resource allocation,
a power control configuration,
a spatial relation.

In an embodiment, the two or more configurations comprise two or more operation configurations.

According to an embodiment, at least one of the two or more operational configurations may, e.g., be a user-performed procedural configuration comprising a series of steps or procedures that users must follow to adjust a behaviour or one or more properties of a system.

In an embodiment, the network entity 200 may, e.g., be configured to generate at least one of the two or more configurations depending on one or more performance targets, which comprise one or more of the following:
a positioning accuracy,
a data rate,
a throughput/a data rata,
a latency,
a QoS KPI,
a SINR,
a transmit power.

According to an embodiment, the network entity 200 may, e.g., be configured to generate at least one of the two or more configurations depending on one or more constraints, which comprise one or more of the following:
time/frequency resources,
a number of available TRPs,
a UE energy level,
   e.g., a battery status of the user equipment 100, or
   e.g., an operation mode (for example, low power with more often sleep phases),
a power operation mode of a user equipment 100.

In an embodiment, the network entity 200 may, e.g., be configured to generate at least one of the two or more configurations depending on one or more UE capabilities.

According to an embodiment, the network entity 200 may, e.g., be configured to generate at least one of the two or more configurations depending on one or more environmental properties, which comprise one or more of the following:
a geographical area of a UE,
an area ID,
a timing information,
a positioning estimate.

In an embodiment, the network entity 200 may, e.g., be configured to generate at least one of the two or more configurations depending on one or more Life Cycle Management model requirements.

According to an embodiment, for generating the two or more configurations, the network entity 200 may, e.g., be configured to interact with one or more RAN entities and/or with one or more UEs and/or with one or more base stations
to identify one or more required resources, and/or
to acquire set of initial measurements/report, and/or
to acquire capabilities and/or supported functionalities from one or more RAN devices.

Furthermore, a user equipment 100 of a wireless communication system according to an embodiment is provided. The user equipment 100 is configured for receiving, from a network entity 200 of the wireless communication system, two or more configurations, wherein the two or more configurations differ in at least one parameter; wherein the two or more configurations are applicable for different environments of the user equipment 100 and/or for different states of the user equipment 100 and/or for different signal propagation conditions and/or for different properties of the user equipment 100. Moreover, the user equipment 100 is configured for selecting one of the two or more configurations depending on a current environment of the user equipment 100 and/or depending on a current state of the user equipment 100 and/or depending on a current signal propagation condition and/or depending on a property of the user equipment 100. Furthermore, the user equipment 100 is configured for applying said one of the two or more configurations at the user equipment 100, for example for transmitting or receiving a reference signal and/or for measuring and/or reporting on a reference signal.

According to an embodiment, the user equipment 100 may, e.g., be configured to select and apply said one of the two or more configurations for machine-learning data collection and/or for machine-learning model monitoring.

Moreover, a user equipment 100 of a wireless communication system according to an embodiment is provided. The user equipment 100 is configured for selecting one of two or more configurations depending on a current environment of the user equipment 100 and/or depending on a current state of the user equipment 100 and/or depending on a property of the user equipment 100; wherein the two or more configurations differ in at least one parameter; wherein the two or more configurations are applicable for different environments of the user equipment 100 and/or for different states of the other user equipment 100 and/or for different signal propagation conditions and/or for different properties of the user equipment 100. Furthermore, the user equipment 100 is configured for applying said one of the two or more configurations at the user equipment 100, for example for transmitting or receiving a reference signal and/or for measuring and/or reporting on a reference signal.

The user equipment 100 is configured to select and apply said one of the two or more configurations for machine-learning data collection and/or for machine-learning model monitoring.

According to an embodiment, the user equipment 100 may, e.g., be configured to receive, from a network entity 200 of the wireless communication system, the two or more configurations.

In an embodiment, the user equipment 100 may, e.g., be further configured to select a different one of the two or more configurations depending on a change of the current environment of the user equipment 100 and/or depending on a change of the current state of the user equipment 100 and/or depending on a change of the current signal propagation condition and/or depending on change of said property of the user equipment 100; and to apply said different one of the two or more configurations at the user equipment 100, for example, for transmitting or receiving the reference signal and/or for measuring and/or reporting on the reference signal.

According to an embodiment, the user equipment 100 may, e.g., be configured to transmit data obtained by the machine-learning data collection and/or for machine-learning model monitoring to the network entity 200.

In an embodiment, the data for the machine-learning data collection and/or for machine-learning model monitoring may, e.g., be measurement data or reporting data.

According to an embodiment, the two or more configurations have been generated by enabling or by activating an operation of an artificial intelligence/machine-learning model, e.g., depending on a Life Cycle Management operation process.

In an embodiment, the artificial intelligence/machine-learning model may, e.g., be a neural network.

According to an embodiment, the network entity 200 may, e.g., comprise the artificial intelligence/machine-learning model or may, e.g., comprise a portion of the artificial intelligence/machine-learning model.

In an embodiment, the artificial intelligence/machine-learning model may, e.g., be distributed over two or more devices. The user equipment 100 may, e.g., comprise a portion of the artificial intelligence/machine-learning model.

According to an embodiment, the user equipment 100 may, e.g., be configured to provide training data and/or validation data to the artificial intelligence/machine-learning model for training and/or validating the artificial intelligence/machine-learning model.

In an embodiment, the training data and/or the validation data may, e.g., comprise the information on a target and/or a request.

According to an embodiment, the training data and/or the validation data may, e.g., comprise the environment information and/or the properties information and/or the capabilities information and/or the Life Cycle Management information.

In an embodiment, the user equipment 100 may, e.g., be configured to provide training data and/or validation data to the artificial intelligence/machine-learning model together with ground truth labels.

According to an embodiment, the user equipment 100 may, e.g., be configured to receive a request from the network entity 200 to provide further training or validation data for training or validating the artificial intelligence/machine-learning model. The user equipment 100 may, e.g., be configured to provide the further training or validation data to the network entity 200.

In an embodiment, the artificial intelligence/machine-learning model may, e.g., be received from the network entity 200.

According to an embodiment, the artificial intelligence/machine-learning model, being received from the network entity 200, may, e.g., be compiled and/or compressed.

In an embodiment, the user equipment may, e.g., be configured to select said one of the two or more configurations depending on information on one or more alarms or monitoring metrics from one or more model monitoring entities of the user equipment 100.

According to an embodiment, at least one of the one or more alarms or monitoring metrics may, e.g., indicate a possible performance degradation of an active artificial intelligence/machine learning model.

In an embodiment, the two or more configurations depend on a target and/or depend on a request.

According to an embodiment, the target may, e.g., comprise a performance target, and wherein the two or more configurations depend on the performance target.

In an embodiment, the target may, e.g., comprise a quality-of service, and wherein the two or more configurations depend on the quality-of-service.

According to an embodiment, the request may, e.g., comprise a request for a service, and wherein the two or more configurations depending on the request for the service.

In an embodiment, the request and/or the information on the target has been specified by a network client 300.

According to an embodiment, the user equipment 100 may, e.g., be different from said network client 300.

In an embodiment, the user equipment 100 may, e.g., be said network client 300.

According to an embodiment, the user equipment 100 may, e.g., be configured to receive one or more updated configurations from the network entity 200 or may, e.g., be configured to receive one or more newly generated configurations from the network entity 200. The user equipment 100 may, e.g., be configured to select one of the one or more updated configurations or to select one of the one or more newly generated configurations depending on the current environment of the user equipment 100 and/or depending on the current state of the user equipment 100 and/or depending on the current signal propagation condition and/or depending on the property of the user equipment 100. Moreover, the user equipment 100 may, e.g., be configured to apply said one of the one or more updated configurations or to apply one of the one or more newly generated configurations at the user equipment 100.

In an embodiment, the two or more configurations depend on environment information and/or depending on properties information and/or depending on capabilities information and/or depending on Life Cycle Management information. The environment information depends on a current environment where the user equipment 100 may, e.g., be currently located, wherein the properties information indicates on one or more current properties of the user equipment 100, wherein the capabilities information indicates one or more general or current capabilities of the user equipment 100, wherein the Life Cycle Management information indicates information on Life Cycle Management of the user equipment 100.

According to an embodiment, the user equipment 100 may, e.g., be configured to receive the two or more configurations together with side information which supports to determine under which circumstances which of the two or more configurations may, e.g., be applicable. Moreover, the user equipment 100 may, e.g., be configured to select said one of the two or more configurations depending on the side information.

In an embodiment, the two or more configurations are applicable for different channel states depending on line-of-sight conditions of the user equipment 100 to one or more base stations, and/or are applicable for different transmission and/or reception qualities, and/or are applicable for different battery states of the user equipment 100.

According to an embodiment, the two or more configurations are applicable for different measurement properties.

In an embodiment, the two or more configurations are applicable for different power related average powers, such as RSRP and/or SINR, and/or are applicable for different path powers, such RSRPP, and/or are applicable for different timings (ToA), and/or are applicable for different timing differences between two or more resources, and/or are applicable for different angular or directional information.

According to an embodiment, one of the two or more configurations may, e.g., comprise a default configuration which may, e.g., be applicable by default, if none of all other configurations of the two or more configurations may, e.g., be applicable.

In an embodiment, the two or more configurations comprise two or more measurement configurations.

According to an embodiment, at least one of the two or more measurement configurations may, e.g., be applicable for a DL or SL resource measurement at a TRP.

In an embodiment, at least one of the two or more measurement configurations may, e.g., comprise certainty information or potential relevant or detectable resources. And/or, at least one of the two or more measurement configurations may, e.g., comprise information to enable the other device to derive necessary/desired information, e.g., detection threshold information, resources group association. And/or, at least one of the two or more measurement configurations may, e.g., comprise measurement procedures, which instruct or assist the device identify a set of relevant resources, e.g., depending on one or more initial measurements.

According to an embodiment, the two or more configurations comprise two or more report configurations.

In an embodiment, at least one of the two or more report configurations may, e.g., be applicable for a DL or SL resource derived from a channel measurement at a UE or an UL derived from a channel measurement at a TRP.

According to an embodiment, at least one of the two or more report configurations may, e.g., be dependent on the environment and measurement characteristics, wherein the UE/TRP selects the dynamic configuration based on a given event. And/or at least one of the two or more report configurations may, e.g., be applicable at the inference device where the AI/ML inference model may, e.g., be installed or to a device or monitoring information to as second entity/device which can be a network entity 200 or in the case of two or multiple sided AI/ML models.

In an embodiment, the two or more configurations comprise two or more transmission configurations.

According to an embodiment, at least one of the two or more transmission configurations may, e.g., be applicable for UL at a UE or for DL resources at a TRP.

In an embodiment, at least one of the two or more transmission configurations depends on a QoS and/or depends on particular environmental conditions and/or depends on characteristics of a received signal.

According to an embodiment, at least one of the two or more transmission configurations comprise at least one of
a time resource allocation and a frequency resource allocation,
a power control configuration,
a spatial relation.

In an embodiment, the two or more configurations comprise two or more operation configurations.

According to an embodiment, at least one of the two or more operational configurations may, e.g., be a user-performed procedural configuration comprising a series of steps or procedures that users must follow to adjust a behaviour or one or more properties of a system.

In an embodiment, at least one of the two or more configurations depends on one or more performance targets, which comprise one or more of the following:
a positioning accuracy,
a data rate,
a throughput/a data rata,
a latency,
a QoS KPI,
a SINR,
a transmit power.

According to an embodiment, at least one of the two or more configurations depends on one or more constraints, which comprise one or more of the following:
time/frequency resources,
a number of available TRPs,
an energy level of the user equipment 100,
   e.g., a battery status of the user equipment 100, or
   e.g., an operation mode (for example, low power with more often sleep phases),
a power operation mode of the user equipment 100.

In an embodiment, at least one of the two or more configurations depends on one or more capabilities of the user equipment 100.

According to an embodiment, at least one of the two or more configurations depends on one or more environmental properties, which comprise one or more of the following:
a geographical area of the user equipment 100,
an area ID,
a timing information,
a positioning estimate.

In an embodiment, at least one of the two or more configurations depends on one or more Life Cycle Management model requirements.

According to an embodiment, for generating the two or more configurations, the user equipment 100 may, e.g., be configured to provide information to the network entity 200 which may, e.g., comprise one or more of the following:
one or more required resources, and/or
a set of initial measurements/report, and/or
capabilities and/or supported functionalities of the user equipment 100.

Furthermore, a network client 300 according to an embodiment is provided. The network client 300 is configured for transmitting information on a target or transmit a request to network entity 200 of a wireless communication system, wherein a reception of the information on the target or a reception of the request by the network entity 200 causes the network entity 200 to generate two or more configurations for another device of the wireless communication system.

According to an embodiment, a reception of the information on the target or a reception of the request by the network entity 200 causes the network entity 200 to generate two or more configurations depending on the target or depending on the request.

In an embodiment, the target may, e.g., comprise a performance target, and/or the target may, e.g., comprise a quality-of service, and/or the request may, e.g., comprise a request for a service.

According to an embodiment, the network client 300 may, e.g., be configured to repeatedly transmit requests to the network entity 200 and/or to repeatedly transmit the information on the target to the network entity 200.

In an embodiment, the two or more configurations are generated using an artificial intelligence/machine-learning model.

According to an embodiment, the two or more configurations are generated using the artificial intelligence/machine-learning model depending on the target or the request.

FIG. 1 illustrates a wireless communication system according to an embodiment comprising a network entity 200 and a user equipment 100.

The network entity 200 is configured for generating two or more configurations for another device of the wireless communication system, wherein the two or more configurations differ in at least one parameter. Moreover, the network entity 200 is configured for transmitting the two or more configurations to another entity of the wireless communication system, for example, to a user equipment 100 or, for example, to a base station. The two or more configurations are applicable for different environments of the other device and/or for different states of the other device and/or for different signal propagation conditions and/or for different properties of the other device.

The user equipment 100 is configured for receiving, from the network entity 200, the two or more configurations and for selecting one of the two or more configurations depending on a current environment of the user equipment 100 and/or depending on a current state of the user equipment 100 and/or depending on a current signal propagation condition and/or depending on a property of the user equipment 100. Furthermore, the user equipment 100 is configured for applying said one of the two or more configurations at the user equipment 100, for example for transmitting or receiving a reference signal and/or for measuring and/or reporting on a reference signal.

According to an embodiment, the wireless communication system may, e.g., further comprise a network client 300 as described above.

Moreover, a wireless communication system according to an embodiment is provided, wherein the wireless communication system comprises a network entity 200 as described above and a network client 300 as described above.

In the following, particular embodiments of the present invention are described.

FIG. 1 illustrates an example for the wireless communication system supporting an AI/ML framework. The system comprises a client, an entity utilizing an AI/ML model, a UE, a BS (gNB) or/and TRP. The client communicates with the AI/ML entity, by requesting a service, an application which can relate to a performance target (accuracy, throughput, etx.), a quality of service or the like. In some scenarios the client is outside the 3GPP system but can directly be connected to a 3GPP-based mobile network (example can be here a Location-Based Services (LBS) client). In other examples, the client can be the network, UE or a gNB.

In particular, FIG. 1 illustrates: A1: The client sets a performance target (e.g., positioning error <30 cm) or request a service associated with certain performance target(s) functionality (ies) or LCM processes. A2/A4: resulting configuration(s) for the UE and/or gNB/TRP respectively (determining for example time/frequency resource allocation, TRPs selection, CIR reporting fidelity, etc.) are generated by the NW/model and transmitted to the UE and/or gNBs. These configurations are applied then in a dynamic manner, based on specific feature values/ranges. A3/A4: If the UE/TRP measurements indicate radio environment conditions that are not covered by the current set of configurations, a feedback signal is sent back to the NW/model indicating this.

The AI/ML entity, where the AI/ML model is deployed, is responsible to identify the service/performance targets. Additionally, it can validate if the performance is achievable or communicate back the best possible performance predicted based on the available resources. In some cases, the entity can reside in the core network (such an LMF, or NWDAF or an 3GGP core or external server), or the gNB or the UE. In some case the AI/ML model can be on multiple sides.

Table 1 describes the LCM processes which can require different data size, Ground Truth Label (GTL) availability and GTL quality requirements, as data collection requirements vary for different functions in the model LCM.

TABLE 1
Data size and quality requirements for different LCM processes

| | | Ground Truth Label |
|---|---|---|
| LCM | Data size | data quality |
| Process/function | requirements | requirements |
| Model Training | High | High |
| Model Fine-tuning/Adaptation | Low | High |
| Model Inference | Low | N/A |
| Offline Monitoring | Med/High | Med/High |
| (Near-) Real-time Monitoring | Low | Low/Med/High |
| Model validation before | Med | High |
| first use | | |

For the model validation before its first use, it could that a large dataset size is not crucial. What is important instead, is to have sufficient data coverage.

For the offline and (near-) real-time monitoring, of course there are approaches that do not require GTLs, as well as approaches that utilize them. In our view though, not all monitoring functions would require high-quality GTLs.

For example, consider that monitoring consists of a fault detection and a fault diagnosis module, as we discuss in our tdoc. Here, during monitoring of a Direct Positioning model, it is detected that the input data distribution deviates from the training data distribution above a certain threshold and an alarm is raised. Despite this, the positioning model can still provide reliable predictions.

In this case, instead of engaging a dedicated PRU to evaluate the exact model performance, a coarser label generated by e.g., GNSS or NR RAT-independent positioning methods could indicate that the model performance is not significantly decreased. Of course, if a stringent model accuracy is required by the use case, then high-quality GTLs would be needed in this case.

The measurements and/or transmissions performed by the UE(s) and/or TRP(s) are the enabler for the Life cycle management for the AI/ML model.

In the following, a dynamic configuration based on radio environment as reported by the UE/TRP according to embodiments is described.

In particular, according to one aspect of an embodiment, a dynamic configuration mechanism (i.e., a dynamic functionality selection/activation/deactivation/switching) is provided to the measuring or transmitting devices such as UE, gNB or TRPs. The device(s) which can apply activate the configuration in a flexible and adaptive manner to apply it in real-time or as needed. Instead of statically setting the configuration parameters, the dynamic framework allows for adjustments so that device applies the configuration dynamically based on certain conditions, variables, or changes in the environment. This approach allows for on-the-fly adjustments and optimization of the configuration to suit the current requirements or circumstances.

In one example, a UE not provided with a dynamic configuration measures certain events reports to the NW. The NW identifies from the UE report that current configuration is not applicable or doesn't achieve a desire quality of service. The Network will configure the UE with a new configuration which is applicable to the new situation/environment/requirement.

On the other hand if the UE is provided with a dynamic configuration it reduce complexity, latency and unnecessarily feedback. Wherein the dynamic configuration enables the UE to decide based on defined or pre-defined conditions or criteria which configuration is applicable.

In a different approach, a UE not provided with a dynamic configuration measures certain events reports to the NW. The NW identifies from the UE report that current configuration is not applicable or doesn't achieve a desired quality of service. The Network will configure the UE with a new configuration which is applicable to the new situation/environment/requirement. In one example, if certain measurements such RSRP of a set of reported DL resources by a UE indicates a low reception rate, the NW can configure the TRPs with an adjusted resource configuration such as increasing the Tx power, applying a power boosted configuration, increasing the repetition rate, etc.

Now dynamic configurations; in particular, types and application according to embodiments are described.

Mechanisms that need different configurations may, e.g., also depend on the LCM process.

In the context of LCM, the following mechanisms are relevant for the solution: data collection, signal generation, operational procedure.

Data collection can refer to the process of gathering information based on measurements or feedback collected from an entity such as a radio access network entity/device(s) such a UE, PRU, gNB, or a TRP.

Signal(s) generation for transmission, is the process of transmitting one or more resources or reference signals (such as PRS, SRS, PRACH, DMRS CSI-RS, SSB by an entity/device such as a radio access network entities like UE, PRU, gNB, or a TRP). An example of such dynamic transmission configuration is the situation of NLOS reception, the AI/ML model knows that in such scenarios a very high bandwidth does not lead to a significant performance gain. Hence the NW can save valuable time/frequency resources by configuring the transmitting devices with an optimum configuration which can be for this example environment and LCM usage dependent.

Operational procedure defines a certain behavior expected from an entity/device such as sleep, active, measurements and/or monitoring behavior.

The data collection, signal generation and/or operational procedure can differ for different LCM processes even if the environment or requirements did not change.

Specific LCM configuration requirements according to particular embodiments are now described.

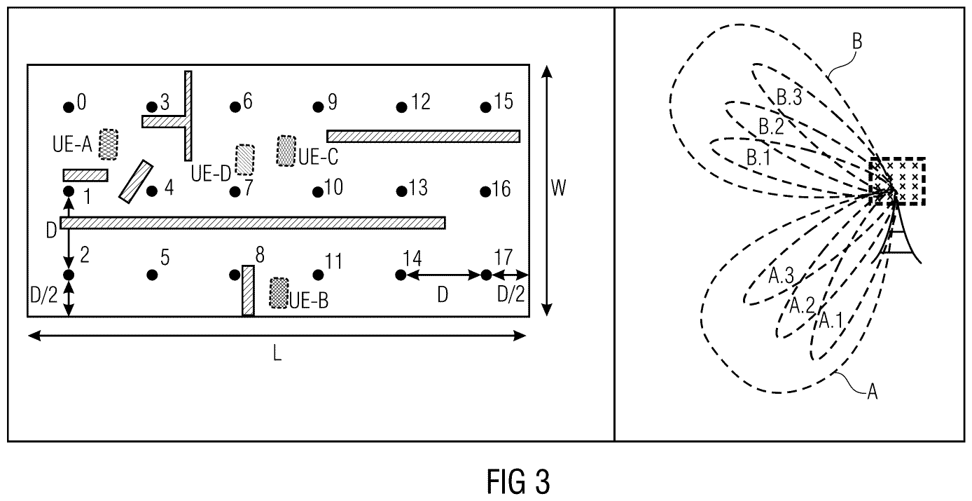

FIG. 3 illustrates an example for LCM discussion. In particular, FIG. 3 illustrates on its left side a positioning example and on its right side beam management with a hierarchical codebook.

Assuming that there are similar use cases (a positioning and a beam management task), as shown in FIG. 3. Then, depending on the LCM process, different configurations would be required.

Training data collection is a process that requires data with high quality for AI/ML model training. This implies that the available resources need to be utilized accordingly. On the other hand, the computational cost and communication overhead for both the UE and the NW is increased.

In one example, the configuration will can be related to the UL, DL or SL resources selection for measurement and/or reporting for the usage of training data collection. In the DL case, this could translate to configurations that utilize for the DL resources or DL resources sets from a single TRP and/or multiple TRPs depending on the application and AI/ML usages as well as device measurement and reporting capability.

Additionally for the purpose of training, the provided configurations include indications to instruct the device generate reliable labels, like acceptable or desired methods such as GNSS, sidelink positioning, RAT positioning, IMU or known landmarks. The dynamic configuration allows the networks to utilize devices when other solution alone for generating GTLs would not suffice, as it might not result in diverse enough datasets with sufficient coverage.

In beam management, similarly the resource selection for measurement and reporting for the training usage can be provided per configuration. In one example, the configuration might indicate a hierarchical beam search is performed, from wider to narrower beams, until the best narrow beam is discovered-a process that entails a large amount of beam measurements and reporting for the UE.

In another aspect, data collection for training AI/ML models can be a resource-intensive task, especially when it comes to gathering labeled data. Collecting labeled data for an AI/ML model training is an “expensive” process that requires intensive use of resources (e.g., a vast set of beam measurements for beam management and reliable mechanisms or dedicated PRUs (positioning reference units) for positioning labels). Dynamic configuration can be utilized for two scenarios: the first is to reduce the complexity of collecting high quality (“expensive”) data. It would not be undesired or not practical to collect data with high accuracy and fidelity, even if this is not directly required by the AI/ML model to be trained. The configuration would ensure that the same data can be re-used to train a model with different input requirements.

For example, for positioning, even if an algorithm utilizes a specific sub-set of TRPs, data from all available TRPs can be collected, since another algorithm could use a different set. In addition, the full channel impulse response CIR (or e.g., Aug. 16, 1932/64 passes) can be reported in training data collection, even if the model requires e.g., power delay prodile PDP or delay profile DP inputs. The PDP information can be extracted from the full CIR and in case another algorithm requires additional information in the input, there is no need for a new data collection process for training.

For beam management, instead of collecting training data by doing a hierarchical search on the codebook, all beams (wide and narrow) could be measured. This way, an algorithm that utilizes knowledge on low RSRP values to infer good beam sets can use the same data for training, as all information would already be available.

In a related aspect of a particular embodiment, in the second scenario dynamic configuration for training can enable using high-quality and high-fidelity data even when the immediate requirements of the AI/ML model might not necessitate it. In this scenario the coordination entity (such as the AI/ML server) utilizes the device capabilities and operation conditions (which can depend on the environments as well as the device power consumption condition or network energy saving operations). In this case the collected data are future proof to train future versions of the model requiring different input requirements.

Even if the AI/ML model does not require frequent measurements, for training data the highest possible measurement/reporting frequency could be required. This could be useful for example in positioning, since dense sequential measurements from the same UE can be used to construct a channel chart, in addition to the model to be trained with the collected data.

Regarding monitoring, for data monitoring, in several cases the requirement in the GTL quality is not strict. The GTL quality requirements might not be as strict in certain scenarios or as for other LCM usages. The primary concern often revolves around maintaining a certain level of one or more of the following.

For example, in several cases for beam management, the target is not identifying the best beam is selected (i.e. measured and/or reported), but that the QoS (e.g., reflected in throughput) is within acceptable limits. So, if a monitoring sub-process determines that throughput is reducing, verifying that the beam selected by the model belongs to the “correct” area covered by the respective wider beam (for example wide beam A has higher RSRP from wide beam B and the model has selected beam A.2), it could suffice.

For positioning, a primary goal may, e.g., be to verify that the model is working as expected, utilizing information from static landmarks. The reasoning here is that if the model predicts the correct position near several landmarks, it would also operate correctly in between, thus not necessitating more complex approaches that would require side-link or GNSS processes or dedicated PRUs.

Regarding validation before a first use, as with monitoring, the same arguments for not requiring perfect GTL quality. In addition, to ensure that the data is validated in several different cases (e.g., different SNR levels or UE speeds), a query can be provided and once the UE measurements match the required values, data for validation/monitoring can be collected ad-hoc.

With respect to inference, according to one embodiment, explicit indication is provided to a device (UE, PRU or TRP) to enable the device identify an LCM process (example monitoring, validation, data collection . . . ). The device applies the identified LCM process to derive an additional process associated configuration the one or more applicable configurations.

In an alternative embodiment, the LCM process can be transparent to the device; wherein the device applies a configuration for data collection, signal generation and/or operational procedure without applying an LCM process indication to derive the configuration.

Regarding types of configuration, according to an embodiment, a configuration may, e.g., relate to one or more of a measurement configuration, a report configuration, a transmission configuration and an operation configuration.

With respect to a measurement configuration, the device may, e.g., receive information related to one or more measurement configurations. The measurement configuration is applicable for a DL or SL resource measurement at the UE or an UL measurement at the TRP.

An example of a measurement configuration may, e.g., include certainty information or potential relevant or detectable resources. Measurement configuration can include information to enable the device to derive the necessary/desired information such as detection threshold information, resources group association. Additional or alternatively the configuration may include potential measurement procedures which instructs or assist the device identify the set of relevant resources based on an initial or multiple initial measurements. In the latter, the device may for example apply in the first stage a channel measurement on one or more resources and, based on the measurements and applied configuration, selects in a later stage the identified additional resources for measurements.

The measurement configuration may, e.g., be applied at the inference device where the AI/ML inference model is installed or to a device providing measurement information or monitoring information to the inference device.

With respect to a report configuration, the device may, e.g., receive information related to one or more report configurations. The report configuration is applicable for a DL or SL resource derived from a channel measurement at the UE or an UL derived from a channel measurement at the TRP.

In some aspects, the dynamic report configuration may, e.g., be dependent on the environment and measurement characteristics. The UE/TRP selects the dynamic configuration based on a given event.

The report configuration may, e.g., be applied at the inference device where the AI/ML inference model is installed or to a device or monitoring information to as second entity/device which can be a network entity or in the case of two or multiple sided AI/ML models.

With respect to a transmission configuration, a transmission configuration may, e.g., be dependent on the usage, environment and/or requirement the UE/TRP can apply a dynamic configuration to update an active transmission resource parameter or to trigger a transmission or to terminate a transmission operation. The transmission configuration is applicable for UL at a UE or DL resources at a TRP. In an example based on a QoS and dependent on certain environmental condition, a lower time/frequency resources can be configured. In other examples, for AI/ML related operation which requires an UL+DL or bi-directional SL, the dynamic configuration can be depended on the characteristics of a given received signal.

With respect to an operation configuration, an operation (al) configuration may, e.g., be user-performed procedural configurations typically involve a series of steps or procedures that users must follow to adjust the behavior or properties of the system. The operational configuration may include configurations to enable the UE to customize it behavior according to certain changes, such as low-battery, and still ensure that AI/ML operation is functional. The operational configuration may, e.g., instruct the UE on the sleep or/and active cycles. In other examples, the UE may be instructed to apply certain monitoring configuration dynamically,

In the following, an event-configuration cycle according to embodiments is considered.

Events may, e.g., be triggering a dynamic configuration.

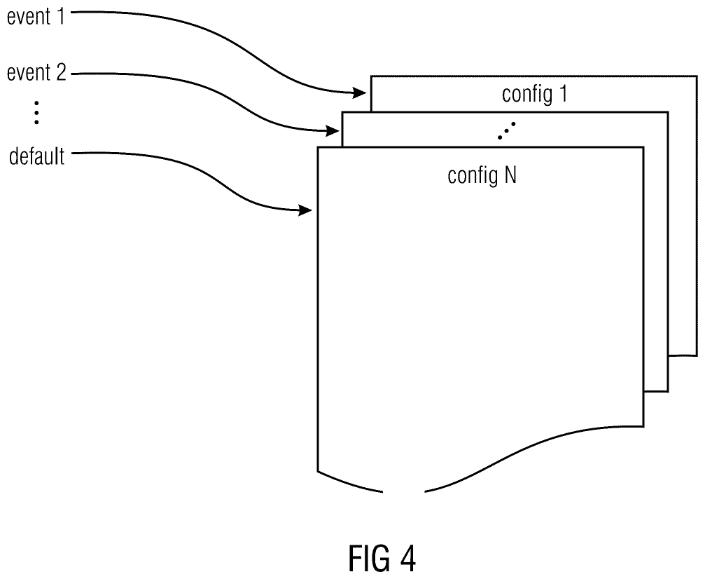

With respect to properties/requirements that generate a dynamic configuration. FIG. 4 illustrates an event/configuration association according to an embodiment. M events may be mapped to N configurations. A default/fallback operation may, e.g., be programmed to be a part of the event operation.

In the scenario shown in FIG. 4 and in Table 2, the entity, potentially the entity for AI/ML model inference, provides the measurement/reporting/transmitting device (UE/TRP) with a set of configurations that are triggered by a different set of events. Alternatively, the pre-configuration can be provided a the measurement/reporting/transmitting device. The configurations and the events/features table seen below are generated ad-hoc depending on the use case properties and requirements.

There are several factors that may, e.g., be considered for this generation of configuration files. It is important to emphasize that these are considered static in the time the configurations are generated. If there is any change (e.g., different performance targets or more TRPs become available), then the configuration generation process might re-initiate. These factors may, e.g., comprise performance targets, constraints, UE capabilities, environmental considerations and model LCM requirements.

Performance targets may, for example comprise a positioning accuracy, a data rate, a throughput (for a beam management use case), a latency, a QoS KPI provided by a different network component, etc.

Constraints may, for example, comprises time/frequency resources, number of available TRPs (e.g., due to network energy management scheduler), operation modes, etc. Additionally, depending on the UE energy levels, GNSS might not be an option. Or side-link capabilities might or might not be supported.

UE capabilities may, for example, comprise supported features due to hardware, compatibility, or implementation. For example, certain UEs will be able to support dynamic configuration operation while other UEs might signal that they are uncapable of dynamic configuration operation. In this case, the NW will provide/activate the configuration sets and/or events only to UE capable devices

Environmental considerations may, for example, comprise certain AI/ML related configurations might be triggered/activated based on the geographical area of the UE. An area ID, a timing information (TA) or a positioning estimate (coarse or fine depending on the application) can assist to identify the optimal configuration.

Model LCM requirements, as, for example, illustrated in Table 1 may, e.g., comprise that different LCM process have different requirements in data size and data quality.

In one aspect, the UE/TRP identifies plurality of configurations wherein at least one parameter differs between the one or more configurations. One or more configurations from the plurality of configurations can have different formats and/or received over different interfaces (such as RRC, LPP, MAC-CE, DCI, or higher layers). One or more configurations might include parameters which updates to amend the one or more configurations from the plurality of configurations or to create a new configuration. The one or more configurations from the plurality of configurations can be acquired simultaneously from the AI/ML model or via a coordinating entity or a NW entity. Alternatively the one or more configurations from the plurality of configurations can be acquired sequentially depending on the environment, requirements and/or UE capabilities.

The process can involve one or more of the following procedures, the steps are not necessarily in a hierarchal order unless mentioned:
(1) The entity (NW/inference model) receives a service request which may include/relate to performance target(s), requirement or an application
(2) The entity can optionally interact with one or more RAN (UE or gNB) entities:
(2a) to identify required resources. The entity can request the required resources configuration to a RAN entity. The entity can alternatively identify based on information or saved information the available resources (for example the entity being a gNB) and/or
(2b) acquire set of initial measurements/report from the UE/TRP such as monitoring reports or measurements on channel information (RSRP, RSSI, RSRPP, timing reporting such Rx-Tx|ToA|TDoA|RSTDIRTOA, angle information AoA, AoD, channel state information being LOS or NLOS, SNR levels, UE speed, etc.), and/or
(2c) acquire capabilities and/or supported functionalities from one or more RAN device/entities. Based on the reported capabilities and/or functionalities the entity identifies the one or more applicable configuration
(3) Based on the procedure in step 1 and/or step 2, the entity generates a set of Configurations for the UE and/or TRPs and/or gNB (see FIG. 4).
(3a) The entity can be based on performance indicators confirm/acknowledge/inform the client on the applicability of the request. The entity can acknowledge or not acknowledge the service request. The entity can provide a certainty score derived from the information in step 2 and offline information on potential achievable targets.
(3b) The NW provides the configurations or a subset of the configuration or parameters from the configuration which are associated with events
(4) The RAN entity receives the configuration(s) and/or event conditions. Each event is triggered when a set of conditions are met (see Table 2). These conditions correspond to specific values/ranges of pre-defined features, shown as rows in (see Table 2). Once the measurements from the UE/TRPs satisfy a set of these conditions, the UE/TRPs dynamically load/select the corresponding configuration.
(5) If the RAN device (UE/TRP/gNB) in case the defined events cannot be mapped to the defined configurations such as measurements do not trigger an event, a default configuration is applied. The RAN device may provide a feedback message to the NW/model. In this case, the NW/model might generate an updated set of configurations/event conditions to react to the situation.

TABLE 2
Event triggers

| | Feature 1 (f₁) | Feature 2 (f₂) | | |
|---|---|---|---|---|
| | (e.g. Number | (e.g. SINR of | | |
| | of TRPs) | received signal) | . . . | Feature N (f_{N}) |
| Event 1 | f₁ < a₁ | f₂ < a₂ | | f_{N} < a₂ |
| Event 2 | a₁ < f₁ < b₁ | f₂ < a₂ | | |
| . . . | . . . | . . . | . . . | . . . |
| Event M | b₁ < f₁ < c₁ | f₂ > a₂ | | |

| | |
|---|---|
| Default | At least one of the event condition not fulfilled |

Different types of features (represented as columns in Table 2 above), that characterize the given use case and set requirements are considered. The values of these features can of course change and based on the specific values and pre-defined thresholds (named a_ₓ and b_ₓ in Table 2 above), different events are activated/triggered.

Examples of such features may, e.g., be:

Measurements that are associated to the applicable conditions of functionalities within 3GPP (e.g., SNR levels, UE speed, Doppler, beam codebook type, PRS identity, model pairing information for two-sided models, etc.).

Information on alarms (potential indicators of performance degradation of the active AI/ML model) or monitoring metrics from model monitoring entities.

High-level features/post-processed information on the UE state. For example, UE orientation/position/velocity, predicted future UE trajectory, etc.

Side information from the network, on the general properties of the radio environment (e.g., throughout, latency, QoS, etc.), reported problems from other UEs, etc.

The specific LCM process and the GTL quality requirements

According to one aspect, the device identifies that the multiple configurations are not applicable and/or the events are not applicable and/or the device expected behavior in some situations is ambiguous; wherein the device applies a default configuration or switch to fallback behavior and/or triggers a feedback/monitoring report.

Concluding, the set of configurations and the accompanying events/features table can be altered by the NW/Inference entity only when one or more of the use case requirements/properties (performance targets, constraints, UE capabilities, model LCM requirements) change.

Alternatively, according to another embodiment, if a combination of values for the indicated features does not map to an event (Table 2), then a default configuration is applied and a feedback to the NW/Inference device is provided, which contains all information/measurements on the feature values. A similar report can be provided to the monitoring entity, when requested or required. A response from the NW can be either a monitoring report either a new set of configurations and event/features table.

In the following device functionalities associated with applying the configuration according to embodiments are described.

In 3GPP, the following process for enabling/configuring a common functionality between the UE and the NW is foreseen:

The UE and the NW report their set of supported functionalities.

The NW (possible performance requirements) decides which functionality to be activated from the set of supported functionalities; possible performance requirements) decides which functionality to be activated from the set of supported functionalities;

A monitoring entity is responsible to evaluate the performance (e.g., in terms of throughput or positioning accuracy) that the AI/ML model that supports/implements the selected functionality achieves. If the performance is degrading, a process for deactivating/switching the current functionality is initiated.

According to embodiments, this process is automated/transparent to the UE/TRP. Based on the performance/constraint/UE capabilities/LCM requirements, as well as selected initial measurements from the UE/TRP, a set of configurations as well as an event/features matrix are generated and transmitted to the UE/TRP. This set covers a variety of functionalities/configurations “close” to the current UE/TRP/radio conditions (for example if the current UE speed is 4 m/s, configurations that cover speeds 1 m/s-8 m/s are included). This way, if the conditions change “slightly,” the UE can dynamically select the proper configurations based on the activation of the corresponding event ( ). The selected event, as well as the values of the features that triggered it are transmitted to the NW along with the requested measurements, in order for the network to apply the proper functionality/configuration in the specific case.

If feedback from the UE/TRP notifies that no event could be triggered (for example because the UE speed is now 15 m/s and there is no configuration in the UE for this case), the NW can either generate new sets of configurations and events/features tables or fallback in a default functionality.

Considering reporting, a UE/TRP reports information derived from measurements according to a configuration. The configuration may, e.g., selected dynamically based on an environmental/requirements events as part of the LCM process data for an AI/ML model training, fine tuning, Inference, monitoring or validation.

In a transmission example according to an embodiment, a UE may, e.g., be configured by the NW (e.g, gNB) or a TRP to transmit an SRS or an on demand RS such as PRS based on a dynamic identified configuration.

The configuration may, e.g., indicate at least one resources comprising:

A time resource allocation and a frequency resource allocation (BW, repetition, comb, etc.) may, e.g., depend on a power control configuration and/or a spatial relation.

In a specific example, the NW may, e.g., identify a UE (or group of UEs) in NLOS conditions for a certain TRP and in LOS for another set of TRPs. The NW entity may request a configuration with different BW configurations for each TRP.

In a measurement example according to an embodiment, a UE may, e.g., be configured by the NW (e. gNB) or a TRP to measure a set of DL resources and reduce over-all complexity independent of the reporting procedure.

For example, interface A1 and a main Inference entity NW/Server/UE/gNB may, e.g., be considered.

A current process in training an AI/ML model (for beam management, positioning or CSI compression) in 3GPP may, e.g., comprise:
1. Collect training data à measurements+Ground Truth Labels (GTLs)
2. Train the model using Supervised Learning
3. Repeat steps 1-2 until a performance criterion is met (i.e., positioning accuracy)
4. (Optional) Compile and compress the model for the target device.
5. Deploy model.

Depending on the design choice, a model can be applied to several different functionalities (i.e., trained with several datasets from different locations, different environment, or radio conditions, etc.) or can be specialized for a specific set of conditions or a specific area.

There are three problems with this training pipeline:

A model trained to achieve the best possible performance (e.g., <10 mm accuracy when we talk for positioning) is probably a larger model that requires the use of all the available resources (e.g., utilize all available TRPs) and usually necessitates intensive measurements and reports from the UE. But this is not always required, as there are several applications where e.g., even 3-5 m accuracy is more than enough.

If several models for the same or different functionality are trained and are available (e.g., LOS/NLOS probabilities, SNR conditions, Doppler, etc.), an optimal performance prediction and switching functionality between models needs to be available. Furthermore, all these models need to be stored and retrieved in the network side.

It is not obvious how to consider the UE capabilities in a flexible way. For example, maybe the hardware capabilities or power levels of a UE cannot support a detailed CIR reporting from several TRPs that could be required as an input to a Direct AI/ML positioning model.

Providing a single AI/ML model would be appreciated that receives a performance target (e.g., positioning accuracy <10 cm) and automatically selects the minimum necessary resources and requests the minimum necessary reporting complexity to achieve this target; and/or that uses the configured resources and reporting to perform the required task (e.g., beam management or positioning); and/or that receives a constraint limit on available resources (e.g., a max of M′ out of M TRPs can be utilized or UE capabilities); and/or that predicts the maximum performance (e.g., positioning accuracy) that could be achieved; and/or that also selects the specific resources and reporting complexity to achieve this performance; and/or that uses the configured resources and reporting to predict the position of the UE.

Model properties (like an LLM/Foundation model) of such a model may, e.g., comprise training and inference.

Regarding training, data augmentation using different algorithms may, e.g., be conducted. Several algorithms with different performance/requirements (as an example for positioning: EKF, Particle Filter, AI/ML models of different sizes using different numbers of TRPs or different CIR sampling/reporting, etc.) can be applied to the same dataset. This way, data generated by approaches with varying resource allocation, reporting configurations and ultimately positioning accuracy can be collected. A performance/constraint conditioned Multi-Task Learning model may, e.g., be employed: Instead of training a model that would provide the best performance, use all the available/augmented data to train a model that would perform the required task (e.g., beam management or positioning) and at the same time would: Either: include the performance target in the input (as well as initial measurements/environmental considerations as described above) and provide all possible configurations to achieve this performance. Or: accept a UE capability report as input (and possible resource constraints, as well as initial measurements/environmental considerations as described above), select resources and reporting complexity within the constraints (configurations) and predict the maximum performance achievable based on the posed constraints. Such multi-task models can be realized as a combination of (offline) reinforcement learning (RL) models (like (constrained) decision transformers) with large language models fine-tuned for (external) function calling.

Regarding inference, inputs may, e.g., comprise performance requirements/possible resource/UE capability constraints, initial measurements/environmental considerations as described above and/or current configurations; and/or UE/TRP measurements; and/or possible alarms/notifications from model monitoring entity; and/or side information (e.g., throughput, SNR measurements, etc.). Outputs may, e.g., comprise output related to the use case (e.g., beam ID or x,y position estimate), and/or an estimation on performance (e.g., positioning accuracy); and/or new configurations (when necessary).

Summarizing, a first network function (e.g. an LMF or a NWDAF) is provided that may, e.g., receive from a second network function (e.g. a GMLC, NEF, AMF, etc), information indicating at least one performance target and/or at least one constraint.

The first network function may, e.g., execute an AI/ML model (e.g., for inference or monitoring), and in response to the information from the second entity, determines a set of resources to be used by one or more third entities and/or reporting mechanisms needed between one or more protocol endpoints (e.g. UE-LMF, TRP-LMF). Moreover, it may, e.g., indicate the needed resource and/or a set of resources to be used to a third entity (e.g. a network function in the core network, a network function in the data network, a network entity or function in the RAN network, or a UE).

The network function (e.g. NWDAF, LMF, etc) may, e.g., further combine the information received from a second network function (e.g. AMF/GMLC) from the information received from one or more third network function (e.g. a UPF, NEF, UDM) to form the applicable constraints for a UE. In line with this example, the information received from the third network function may be policy parameters stored in the subscription database (e.g. the UDR), information provided to the network from the external application functions (e.g. via NEF) or from the policy control function (pcf) or charging function (CHF).

The network function (e.g. the NWDAF, LMF) may, e.g., provide information to one or more network entities, to coordinate the network entities in the access network and/or the core network, either directly (e.g. NG-RAN nodes using NRPPa) or via a second network node (e.g. via AMF).

The network function may, e.g., further predict the network entities (e.g. the TRPs) that need to participate in transmitting and/or receiving the radio signal.

The network function may, e.g., further predict the configuration of radio signal to be transmitted and/or the configuration of radio signal to receive, perform measurement on and/or report.

The network function may, e.g., further use the model to predict the location dependent parameters (e.g. position, velocity, orientation, etc.) of the UE and/or predict the most suitable radio parameters (e.g. beam index, CSI, CQI, RANK under the given circumstances).

In the following practical examples according to embodiments are described.

Examples relate to direct/assisted AI/ML driven positioning.

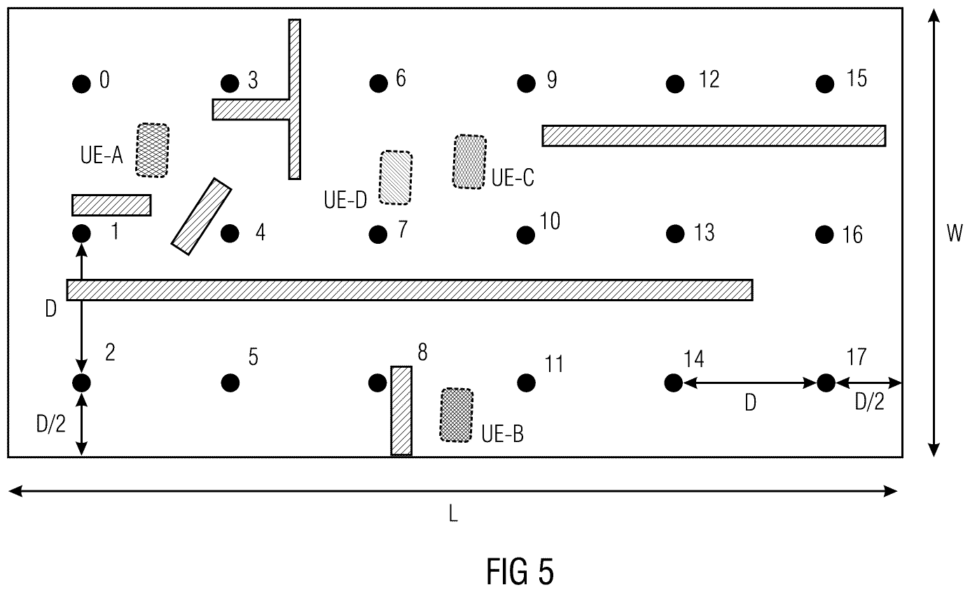

FIG. 5 illustrates a positioning dynamic configuration according to an embodiment.

In the example of FIG. 5, a scenario describes four different user equipment (UE) scenarios in a wireless communication system where UEs report measurements and the server computes the position are provided. Each scenario has unique characteristics and requirements and configurations associated with conditions such as LOS (line of sight) and NLOS (non-line of sight) links to perform positioning:

In a first scenario, a UE-A has insufficient number of LOS links to perform positioning. In this scenario, UE-A does not have enough LOS links to perform positioning accurately. Therefore, the server needs high-resolution reporting for the LOS links, especially in the first arrival path, to compensate for the lack of information. For NLOS links, information related to high-power multipath reflections is more important than high resolution around the first path. Thus, the measurement and reporting configuration for UE-A should prioritize high-resolution reporting for LOS links and high-power multipath reflections for NLOS links. In such a scenario, UE-A may, e.g., apply CIR report config_101 on the LOS resources (for example focusing on the FAP part(s)) and a report config_102 for the NLOS identified resources (NLOS config can include lower resolution and more paths)

In a second scenario, a UE-C has sufficient number of LOS links to perform positioning. In particular, UE-C may, e.g., have enough LOS links to perform positioning accurately. However, NLOS reporting is insufficient, and the configuration indicates that an adequate number of detectable LOS links are available. Therefore, the measurement and reporting configuration for UE-C should prioritize high-resolution reporting for LOS links. The LOS related configuration can include a phase reporting configuration and/or CIR window configuration around the first path and/or one or more LOS potential path (i.e. detected with a low threshold and can correspond to a false detection due to channel or interference). In such a scenario, UE-C can apply CIR report config_201 on the LOS resources (for example focusing on the FAP part(s)) and configured to ignore NLOS identified resources if the number of LOS is sufficient For example, in CIR reporting one could have:
(1) N-Path reporting, real valued: For N path we report delay and magnitude
(2) N-Path reporting, complex valued: For N path we report delay+I/Q (or magnitude and phase)

$$PDP ( power delay profile ) = magnitude of the CIR sampled equally spaced \qquad ( 3 )$$

$$CIR ( complex valued ) = I / Q values ( or magnitude and phase ) sampled equally spaced \qquad ( 4 )$$

$$“ truncated CIR ” = CIR reporting + “ window start ” ( e . g . ToA estimate - 2 samples ) \qquad ( 5 )$$

(6) Super resolution PDP/CIR reporting (similar to #1 or #2 but with high value for N or very high sampling frequency

In a third scenario, a UE-B may, e.g., have LOS links with special considerations. In particular, UE-B may, e.g., have LOS links, and in a challenging environment, multipath information is desired, despite the LOS condition. Therefore, the measurement and reporting configuration for UE-B should prioritize high-resolution reporting for LOS links and prioritize multipath information. In such a scenario, the channel state alone is not sufficient a different reporting configuration might be desired.

In a fourth scenario, a UE-D may, e.g., be in similar conditions to UE-C, however the requirements may, e.g., be loose compared to UE-C. In particular, UE-D may, e.g., have similar conditions to UE-C, but the requirements are not as strict. There is no need for high-resolution reporting or measurements to resolve the paths. Therefore, the measurement and reporting configuration for UE-D can be relaxed, and no high-resolution reporting or measurements are required.

The above scenarios illustrate how different factors and conditions such as the availability of LOS links or SINR or RSPR level, Measurement quality the physical environment, and the specific requirements of each UE can influence the optimal reporting configuration in a wireless communication system using AI/ML for positioning. If the device (e.g. UE, PRU gNB or TRP) can identify these conditions, it can dynamically apply the flexible and adaptable configurations to ensure efficient and accurate system operation in diverse conditions. Accordingly, the UE can apply the optimum configuration for which is related to type of measurement and/or report content and information (CIR, PDP, DP) also it can assist in identifying the relevant resources “useful for the AI/ML model).

Similarly, the following scenarios can be provided in the context of beam selection within a wireless communication network that uses AI/ML models.

In a first scenario, a UE-A may, e.g., be experiencing significant multipath propagation due to numerous nearby buildings. While many beams are available, their quality varies rapidly due to frequent changes in the environment (such as moving vehicles or pedestrians). In this scenario, the reporting or measurement configuration prioritize low varying resources associated with the consistent beams which might not necessarily correspond to highest RSRP set.

In a second scenario, UE-B may, e.g., see few moving obstacles, resulting in strong Line-of-Sight (LOS) or multipath paths to the base station. In this scenario, the AI/ML model configuration requires the strongest beam which often correspond to the highest RSRP for the best possible connection quality. The report configuration can include RSRPP in addition or instead RSRP to identify path specific power for the purpose of beam selection.

In a third scenario, UE-C may, e.g., be in a rapidly moving vehicle, resulting in a constantly changing wireless environment. In this case, the AI/ML model configuration requires resources consistent during beam tracking and/or handover from (or between) the one or more base stations.

In a fourth scenario, UE-D may, e.g., be in a high dense scenario with extreme many. In this scenario, the dynamic configuration can provided to ensure that multiple UEs experience a similar QoS within the selected AI/ML model.

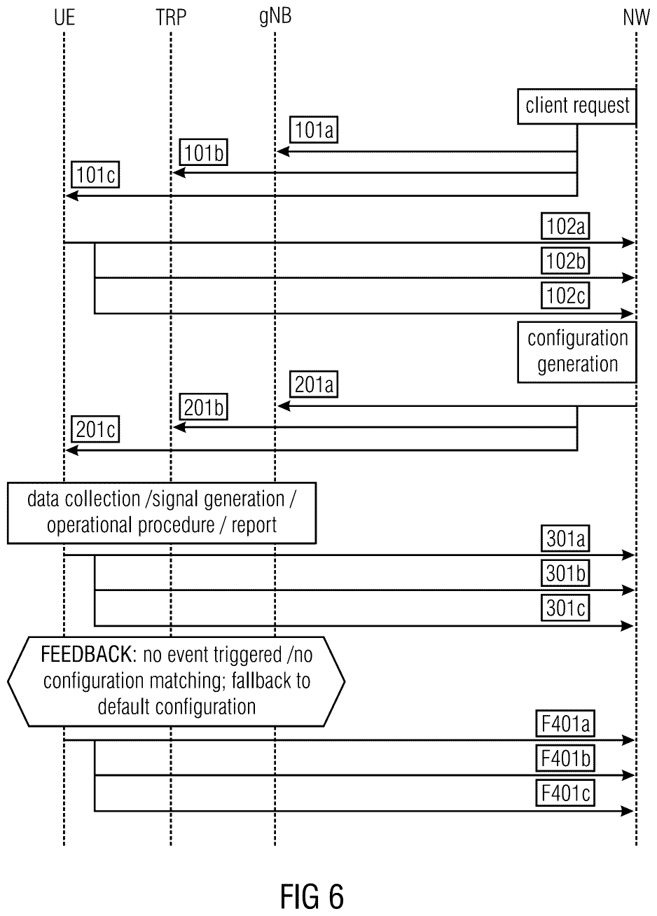

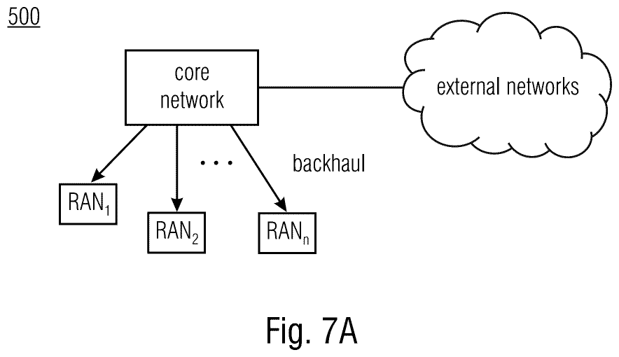

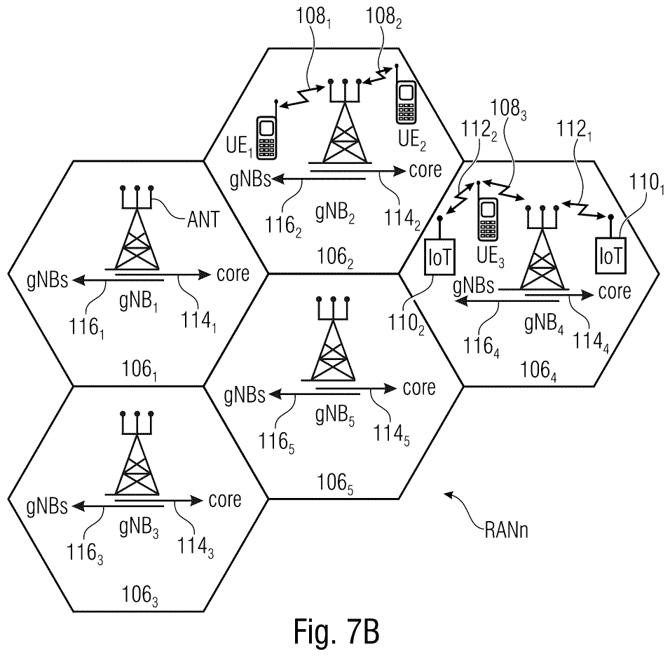

FIG. 6 illustrates a communication flow chart in a wireless communication system according to an embodiment.

In FIG. 6, the network may, e.g., transmit in step 101a a client request to a gNB, and/or the network may, e.g., transmit the client request in step 101b to a TRP, and/or the network may, e.g., transmit the client request in step 101c to a UE.

In steps 102a and/or 102b and/or 102c, the UE and/or the TRP and/or the gNB may, e.g., respond to a receipt of the client request (e.g., by acknowledging reception of the client request).

The network may, e.g., then transmit configuration information to the gNB (in step 201a), and/or to the TRP (in step 201b), and/or to the UE (in step 201c).

Then, data collection and/or signal generation and/or an operational procedure may, e.g., be conducted by the UE and/or by the TRP and/or by the gNB, and the UE (in step 301a) and/or the TRP (in step 301b) and/or the gNB (in step 301c) may, e.g., transmit a report thereon to the network.

In some situations, the UE (in step F401a) and/or the TRP (in step F401b) and/or the gNB (in step F401c) may, e.g., provide feedback to the network, e.g., that no event has been triggered, and/or that the configuration does not match, and/or that a fallback to a default configuration has been conducted.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

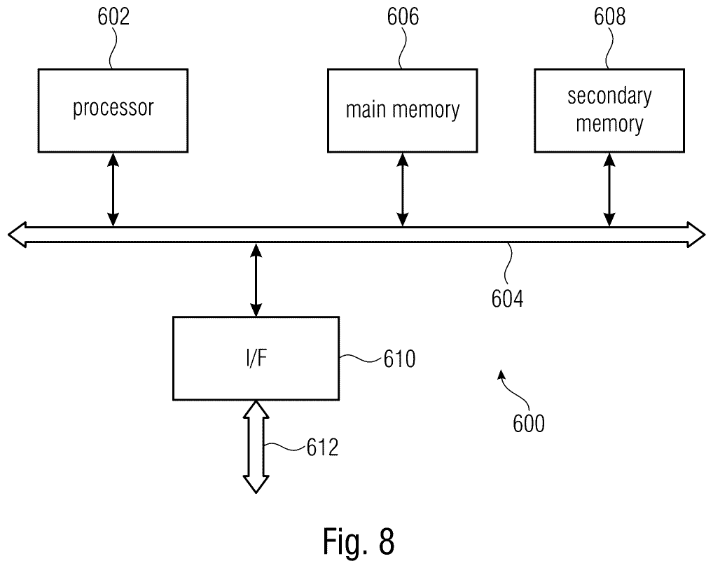

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 8 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein.

The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

ABBREVIATIONS

| Abbreviation | Definition |
|---|---|
| 3GPP | third generation partnership project |
| 5GC | 5G core network |
| BS | base station |
| CSI-RS | channel state information reference signal |
| DMRS | demodulation reference signal |
| DOA | direction of arrival |
| E-CID | enhanced cell ID |
| eNB | evolved node b |
| E-SMLC | evolved serving mobile location center. |
| E-UTRA | evolved UMTS terrestrial radio access |
| gNB | next generation node-b |
| GPS | Global Positioning System |
| LMF | location management function |
| LMU | location measurement unit |
| LPP | LTE positioning protocol |
| LTE | Long-term evolution |
| NG | next generation |
| ng-eNB | next generation eNB |
| NG-RAN | either a gNB or an ng-eNB |
| NR | new radio |
| NRPPa | new radio positioning protocol a |
| OTDOA | observe time difference of arrival |
| PRS | positioning reference signal |
| PTRS | phase tracking reference signal |
| QCL | quasi colocation |
| RAN | radio access network |
| RP | reception point |
| RSTD | reference signal time difference |
| RTOA | relative time of arrival |
| RTT | round trip time |
| SA | Standalone |
| SRS | sounding reference signal |
| TDM | Time Domain Multiplexing |
| TOF | time of flight |
| TRP | transmission reception point |
| RS | reference signal |
| QCL | quasi co-located |
| AoA | Angle of Arrival |
| AoD | Angle of Departure |
| PAS | Power Angular Spectrum |
| NR | New Radio |
| gNB | next generation node-b |
| GPS | Global Positioning System |
| LMF | location management function |
| LMU | location measurement unit |
| LPP | LTE positioning protocol |
| LTE | Long-term evolution |
| NG | next generation |
| ng-eNB | next generation eNB |
| NG-RAN | either a gNB or an ng-eNB |
| NR | new radio |
| CA | carrier aggregation |
| CAM | Cooperative Awareness Message |
| DAS | distributed antenna systems |
| DL | Downlink |
| FL | Frequency layer |
| FC | Frequency component. This is either a BWP |
| | of a wideband carrier or |
| GNSS | Global navigation satellite system |
| OOC | Out-Of-Coverage |
| PSFCH | Physical Sidelink Feedback Channel |
| P-UE | Pedestrian UE: should not be limited to |
| | pedestrians, but represents any UE |
| RS | Reference signal |
| RE | resource elements |
| SINR | Signal to interference and noise ratio |
| SL | Sidelink |
| SPRS, SP- | Sidelink positioning reference signals |
| V2X | Vehicle to anything |
| VRU | Vulnerable road user |
| V-UE | Vehicular UE |
| BWP | Bandwidth Part |
| TEG | Timing Error Group |
| ZC | Zadoff-Chu sequence |
| UE | User equipment |
| UL | Uplink |
| Uu (interface) | Interface between UE |
| ToA | Time of Arrival |
| TDOA | Time Difference of Arrival |
| LOS | Line of sight |
| PRU | Positioning reference unit |
| ToF | Time of flight |

1. A network entity of a wireless communication system, wherein the network entity is configured for
generating two or more configurations for another device of the wireless communication system, wherein the two or more configurations differ in at least one parameter; and
transmitting the two or more configurations to another entity of the wireless communication system, for example, to a user equipment or, for example, to a base station,
wherein the two or more configurations are applicable for different environments of the other device and/or for different states of the other device and/or for different signal propagation conditions and/or for different properties of the other device.

2. A network entity according to claim 1,
wherein the two or more configurations are applicable for machine-learning data collection and/or for machine-learning model monitoring.

3. A network entity according to claim 1,
wherein the network entity is configured to generate the two or more configurations by enabling or activating an artificial intelligence/machine-learning model, e.g., depending on a Life Cycle Management process.

4. A network entity according to claim 3,
wherein the network entity is configured to generate the two or more configurations by enabling or activating the artificial intelligence/machine-learning model, e.g., depending on a Life Cycle Management process,
wherein the network entity is configured to feed input information into the artificial intelligence/machine-learning model, to obtain an output of the artificial intelligence/machine-learning model,
wherein, in response to receiving the input information, the artificial intelligence/machine-learning model is configured to output at least one of the two or more configurations as the output of the artificial intelligence/machine-learning model; or
wherein, in response to receiving the input information, the artificial intelligence/machine-learning model is configured to output an intermediate output as the output of the artificial intelligence/machine-learning model; and the network entity is configured to generate at least one of the two or more configurations using the intermediate output.

5. A network entity according to claim 3,
wherein the network entity is configured to receive from the other entity data for the artificial intelligence/machine-learning model.

6. A network entity of a wireless communication system, wherein the network entity is configured for
receiving a target (e.g., a performance target),
requesting and/or receiving information and/or identifying configurations for necessary resources and/or measurement and/or reporting depending on the target,
determining at least one resource and/or measurement and/or report configuration to achieve the target,
enabling or activating an artificial intelligence/machine-learning model using the configured resources and using received reporting to perform a task (e.g., beam management or positioning);
and/or
receiving a constraint limit on one or more available resources,
predicting a maximum performance (e.g., positioning accuracy) that is achievable,
selecting and configuring resources and/or selecting a reporting complexity to achieve the maximum performance,
enabling or activating an artificial intelligence/machine-learning model using the configured resources and using a received reporting to perform a task (e.g., to predict a position of a UE).

7. A network entity according to claim 6,
wherein the network entity is configured to provide information on the at least one resource and/or on the at least one measurement and/or on the at least one report configuration, which has been determined by the network entity to achieve the target, to a user equipment and/or to a TRP.

8. A network entity according claim 7,
wherein the network entity is configured to receive from another entity of the wireless communication system data for the artificial intelligence/machine-learning model.

9. A network entity according to claim 6,
wherein the data for the artificial intelligence/machine-learning model is measurement data or reporting data.

10. A network entity according to claim 6,
wherein the network entity comprises the artificial intelligence/machine-learning model.

11. A network entity according to claim 6,
wherein the artificial intelligence/machine-learning model is distributed over two or more devices.

12. A network entity according to claim 6,
wherein the artificial intelligence/machine-learning model is a neural network.

13. A network entity according to claim 6,
wherein the network entity is configured to receive training or validation data for the artificial intelligence/machine-learning model and ground truth labels; and wherein the network entity is configured to train and/or to validate the artificial intelligence/machine-learning model using the training or validation data and the ground truth labels.

14. A network entity according to claim 6,
wherein the network entity is configured to employ data augmentation using two or more algorithms on a same data set for training the artificial intelligence/machine-learning model.

15. A network entity according to claim 6,
wherein the network entity is configured to train the artificial intelligence/machine-learning model depending on a performance condition and/or depending on a constraint condition.

16. A network entity according to claim 6,
wherein the network entity is configured to request further training or validation data for training or validating the artificial intelligence/machine-learning model from the other device,
wherein the network entity is configured to receive the further training or validation data from the other device, and
wherein the network entity is configured to train or to validate the artificial intelligence/machine-learning model using the training or validation data.

17. A network entity according to claim 6,
wherein the network entity comprises a monitoring entity for evaluating a performance of the artificial intelligence/machine-learning model.

18. A network entity according to claim 6,
wherein the artificial intelligence/machine-learning model is trained using supervised learning.

19. A network entity according to claim 6,
wherein the artificial intelligence/machine-learning model is compiled and/or compressed for a target device.

20. A network entity according to claim 19,
wherein the artificial intelligence/machine-learning model, being compiled and/or compressed, is transmitted to the target device.

21. A network entity according to claim 6,
wherein the network entity is configured to receive the environment information and/or the properties information and/or the capabilities information and/or the Life Cycle Management information; or
wherein the network entity is configured to generate the input information depending on the environment information and/or the properties information and/or the capabilities information and/or the Life Cycle Management information.

22. A network entity according to claim 1, wherein the network entity is configured for
receiving a target (e.g., a performance target),
requesting and/or receiving information and/or identifying configurations for necessary resources and/or measurement and/or reporting depending on the target,
determining at least one resource and/or measurement and/or report configuration to achieve the target,
enabling or activating an artificial intelligence/machine-learning model using the configured resources and using received reporting to perform a task (e.g., beam management or positioning);
and/or
receiving a constraint limit on one or more available resources,
predicting a maximum performance (e.g., positioning accuracy) that is achievable,
selecting and configuring resources and/or selecting a reporting complexity to achieve the maximum performance,
enabling or activating an artificial intelligence/machine-learning model using the configured resources and using a received reporting to perform a task (e.g., to predict a position of a UE),
wherein the network entity is configured for
generating two or more configurations for another device of the wireless communication system, wherein the two or more configurations differ in at least one parameter; and
transmitting the two or more configurations to another entity of the wireless communication system, for example, to a user equipment or, for example, to a base station,
wherein the two or more configurations are applicable for different environments of the other device and/or for different states of the other device and/or for different signal propagation conditions and/or for different properties of the other device.

23. A network entity according to claim 1, wherein the network entity is configured for
receiving a target (e.g., a performance target),
requesting and/or receiving information and/or identifying configurations for necessary resources and/or measurement and/or reporting depending on the target,
determining at least one resource and/or measurement and/or report configuration to achieve the target,
enabling or activating an artificial intelligence/machine-learning model using the configured resources and using received reporting to perform a task (e.g., beam management or positioning);
and/or
receiving a constraint limit on one or more available resources,
predicting a maximum performance (e.g., positioning accuracy) that is achievable,
selecting and configuring resources and/or selecting a reporting complexity to achieve the maximum performance,
enabling or activating an artificial intelligence/machine-learning model using the configured resources and using a received reporting to perform a task (e.g., to predict a position of a UE),
wherein the network entity is configured to generate the two or more configurations depending on a target and/or depending on a request.

24. A network entity according to claim 23,
wherein the target comprises a performance target, and wherein the network entity is configured to generate the two or more configurations depending on the performance target.

25. A network entity according to claim 23,
wherein the target comprises a quality-of service, and wherein the network entity is configured to generate the two or more configurations depending on the quality-of-service.

26. A network entity according to claim 23,
wherein the request comprises a request for a service, and wherein the network entity is configured to generate the two or more configurations depending on the request for the service.

27. A network entity according to claim 23,
wherein the network entity is configured to receive the request and/or the information on the target from a network client.

28. A network entity according to claim 27,
wherein the network entity is configured to repeatedly receive requests from the network client and/or to repeatedly receive the information on the target from the network client,
wherein the network entity is configured to update at least one of the two or more configurations or to newly generate at least one of the two or more configurations depending on a change of the requests and/or depending on a change of the target.

29. A network entity according to claim 27,
wherein the network client is different from the other device for which the network entity is configured to generate the two or more configurations.

30. A network entity according to claim 27,
wherein the network client is the other device for which the network entity is configured to generate the two or more configurations.

31. A network entity according to claim 6,
wherein the network entity is configured to receive environment information and/or properties information and/or capabilities information and/or Life Cycle Management information from the other device, and
wherein the network entity is configured to generate the two or more configurations depending on the environment information and/or depending on the properties information and/or depending on the capabilities information and/or depending on Life Cycle Management information,
wherein the environment information depends on a current environment where the other device is currently located,
wherein the properties information indicates on one or more current properties of the other device,
wherein the capabilities information indicates one or more general or current capabilities of the other device,
wherein the Life Cycle Management information indicates information on Life Cycle Management of the other device.

32. A network entity according to claim 31,
wherein the network entity is configured to repeatedly receive the environment information and/or the properties information and/or the capabilities information and/or the Life Cycle Management information from the other device, and
wherein the network entity is configured to update the two or more configurations or to generate newly generate the two or more configurations depending on a change of the environment information and/or the properties information and/or the capabilities information and/or the Life Cycle Management information from the other device.

33. A network entity according to claim 6,
wherein the two or more configurations are provided together with side information for supporting to determine under which circumstances which of the two or more configurations is applicable.

34. A network entity according claim 6,
wherein the other device is a user equipment.

35. A network entity according to claim 34,
wherein the two or more configurations are applicable for different channel states depending on line-of-sight conditions of the user equipment to one or more base stations, and/or are applicable for different transmission and/or reception qualities, and/or are applicable for different battery states of the user equipment.

36. A network entity according to claim 34,
wherein the two or more configurations are applicable for different measurement properties.

37. A network entity according to claim 36,
wherein the two or more configurations are applicable for different power related average powers, such as RSRP and/or SINR, and/or are applicable for different path powers, such RSRPP, and/or are applicable for different timings (ToA), and/or are applicable for different timing differences between two or more resources, and/or are applicable for different angular or directional information.

38. A network entity according to claim 6,
wherein the other device is a base station.

39. A network entity according to claim 6,
wherein one of the two or more configurations comprises a default configuration or a fallback configuration, which is applicable by default, if none of all other configurations of the two or more configurations is applicable.

40. A network entity according to claim 6,
wherein the two or more configurations comprise two or more measurement configurations.

41. A network entity according to claim 40,
wherein at least one of the two or more measurement configurations is applicable for a DL or SL resource measurement at a TRP.

42. A network entity according to claim 40,
wherein at least one of the two or more measurement configurations comprises certainty information or potential relevant or detectable resources; and/or
wherein at least one of the two or more measurement configurations comprises information to enable the other device to derive necessary/desired information, e.g., detection threshold information, resources group association; and/or
wherein at least one of the two or more measurement configurations comprises measurement procedures, which instruct or assist the device identify a set of relevant resources, e.g., depending on one or more initial measurements.

43. A network entity according to claim 6,
wherein the two or more configurations comprise two or more report configurations.

44. A network entity according to claim 43,
wherein at least one of the two or more report configurations is applicable for a DL or SL resource derived from a channel measurement at a UE or an UL derived from a channel measurement at a TRP.

45. A network entity according to claim 43,
wherein at least one of the two or more report configurations is dependent on the environment and measurement characteristics, wherein the UE/TRP selects the dynamic configuration based on a given event, and/or
wherein at least one of the two or more report configurations is applicable at the inference device where the AI/ML inference model is installed or to a device or monitoring information to as second entity/device which can be a network entity or in the case of two or multiple sided AI/ML models.

46. A network entity according to claim 6,
wherein the two or more configurations comprise two or more transmission configurations.

47. A network entity according to claim 46,
wherein at least one of the two or more transmission configurations is applicable for UL at a UE or for DL resources at a TRP.

48. A network entity according to claim 46,
wherein at least one of the two or more transmission configurations depends on a QoS and/or depends on particular environmental conditions and/or depends on characteristics of a received signal.

49. A network entity according to claim 46,
wherein at least one of the two or more transmission configurations comprise at least one of
a time resource allocation and a frequency resource allocation,
a power control configuration,
a spatial relation.

50. A network entity according to claim 6,
wherein the two or more configurations comprise two or more operation configurations.

51. A network entity according to claim 50,
wherein at least one of the two or more operational configurations is a user-performed procedural configuration comprising a series of steps or procedures that users must follow to adjust a behaviour or one or more properties of a system.

52. A network entity according to claim 6,
wherein the network entity is configured to generate at least one of the two or more configurations depending on one or more performance targets, which comprise one or more of the following:
a positioning accuracy,
a data rate,
a throughput/a data rata,
a latency,
a QoS KPI,
a SINR,
a transmit power.

53. A network entity according to claim 6,
wherein the network entity is configured to generate at least one of the two or more configurations depending on one or more constraints, which comprise one or more of the following:
time/frequency resources,
a number of available TRPs,
a UE energy level,
e.g., a battery status of the user equipment, or
e.g., an operation mode (for example, low power with more often sleep phases),
a power operation mode of a user equipment.

54. A network entity according to claim 6,
wherein the network entity is configured to generate at least one of the two or more configurations depending on one or more UE capabilities.

55. A network entity according to claim 6,
wherein the network entity is configured to generate at least one of the two or more configurations depending on one or more environmental properties, which comprise one or more of the following:
a geographical area of a UE,
an area ID,
a timing information,
a positioning estimate.

56. A network entity according to claim 6,
wherein the network entity is configured to generate at least one of the two or more configurations depending on one or more Life Cycle Management model requirements.

57. A network entity according to claim 6,
wherein, for generating the two or more configurations, the network entity is configured to interact with one or more RAN entities and/or with one or more UEs and/or with one or more base stations
to identify one or more required resources, and/or
to acquire set of initial measurements/report, and/or
to acquire capabilities and/or supported functionalities from one or more RAN devices.

58. A user equipment of a wireless communication system, wherein the user equipment is configured for
receiving, from a network entity of the wireless communication system, two or more configurations, wherein the two or more configurations differ in at least one parameter; wherein the two or more configurations are applicable for different environments of the user equipment and/or for different states of the user equipment and/or for different signal propagation conditions and/or for different properties of the user equipment,
selecting one of the two or more configurations depending on a current environment of the user equipment and/or depending on a current state of the user equipment and/or depending on a current signal propagation condition and/or depending on a property of the user equipment;
applying said one of the two or more configurations at the user equipment, for example for transmitting or receiving a reference signal and/or for measuring and/or reporting on a reference signal.

59. A user equipment according to claim 58,
wherein the user equipment is configured to select and apply said one of the two or more configurations for machine-learning data collection and/or for machine-learning model monitoring.

60. A user equipment of a wireless communication system, wherein the user equipment is configured for
selecting one of two or more configurations depending on a current environment of the user equipment and/or depending on a current state of the user equipment and/or depending on a property of the user equipment; wherein the two or more configurations differ in at least one parameter; wherein the two or more configurations are applicable for different environments of the user equipment and/or for different states of the other user equipment and/or for different signal propagation conditions and/or for different properties of the user equipment; and
applying said one of the two or more configurations at the user equipment, for example for transmitting or receiving a reference signal and/or for measuring and/or reporting on a reference signal;
wherein the user equipment is configured to select and apply said one of the two or more configurations for machine-learning data collection and/or for machine-learning model monitoring.

61. A user equipment according to claim 60,
wherein the user equipment is configured to receive, from a network entity of the wireless communication system, the two or more configurations.

62. A user equipment according to claim 60,
wherein the user equipment is further configured to
select a different one of the two or more configurations depending on a change of the current environment of the user equipment and/or depending on a change of the current state of the user equipment and/or depending on a change of the current signal propagation condition and/or depending on change of said property of the user equipment; and
apply said different one of the two or more configurations at the user equipment, for example, for transmitting or receiving the reference signal and/or for measuring and/or reporting on the reference signal.

63. A user equipment according to claim 60,
wherein the user equipment is configured to transmit data obtained by the machine-learning data collection and/or for machine-learning model monitoring to the network entity.

64. A user equipment according to claim 63,
wherein the data for the machine-learning data collection and/or for machine-learning model monitoring is measurement data or reporting data.

65. A user equipment according to claim 60,
wherein the two or more configurations have been generated by enabling or by activating an operation of an artificial intelligence/machine-learning model, e.g., depending on a Life Cycle Management operation process.

66. A user equipment according to claim 65,
wherein the artificial intelligence/machine-learning model is a neural network.

67. A user equipment according to claim 65,
wherein the network entity comprises the artificial intelligence/machine-learning model or comprises a portion of the artificial intelligence/machine-learning model.

68. A user equipment according to claim 65,
wherein the artificial intelligence/machine-learning model is distributed over two or more devices,
wherein the user equipment comprises a portion of the artificial intelligence/machine-learning model.

69. A user equipment according to claim 65,
wherein the user equipment is configured to provide training data and/or validation data to the artificial intelligence/machine-learning model for training and/or validating the artificial intelligence/machine-learning model.

70. A user equipment according to claim 69,
wherein the training data and/or the validation data comprises the information on a target and/or a request.

71. A user equipment according to claim 69,
wherein the training data and/or the validation data comprises the environment information and/or the properties information and/or the capabilities information and/or the Life Cycle Management information.

72. A user equipment according to claim 69,
wherein the user equipment is configured to provide training data and/or validation data to the artificial intelligence/machine-learning model together with ground truth labels.

73. A user equipment according to claim 69,
wherein the user equipment is configured to receive a request from the network entity to provide further training or validation data for training or validating the artificial intelligence/machine-learning model, and
wherein the user equipment is configured to provide the further training or validation data to the network entity.

74. A user equipment according to claim 69,
wherein the artificial intelligence/machine-learning model is received from the network entity.

75. A user equipment according to claim 74,
wherein the artificial intelligence/machine-learning model, being received from the network entity, is compiled and/or compressed.

76. A user equipment according to claim 60,
wherein the user equipment is configured to select said one of the two or more configurations depending on information on one or more alarms or monitoring metrics from one or more model monitoring entities of the user equipment.

77. A user equipment according to claim 76,
wherein at least one of the one or more alarms or monitoring metrics indicates a possible performance degradation of an active artificial intelligence/machine learning model.

78. A user equipment according to claim 60,
wherein the two or more configurations depend on a target and/or depend on a request.

79. A user equipment according to claim 78,
wherein the target comprises a performance target, and wherein the two or more configurations depend on the performance target.

80. A user equipment according to claim 78,
wherein the target comprises a quality-of service, and wherein the two or more configurations depend on the quality-of-service.

81. A user equipment according to claim 78,
wherein the request comprises a request for a service, and wherein the two or more configurations depending on the request for the service.

82. A user equipment according to claim 78,
wherein the request and/or the information on the target has been specified by a network client.

83. A user equipment according to claim 82,
wherein the user equipment is different from said network client.

84. A user equipment according to claim 82,
wherein the user equipment is said network client.

85. A user equipment according to claim 60,
wherein the user equipment is configured to receive one or more updated configurations from the network entity or is configured to receive one or more newly generated configurations from the network entity, and
wherein the user equipment is configured to select one of the one or more updated configurations or to select one of the one or more newly generated configurations depending on the current environment of the user equipment and/or depending on the current state of the user equipment and/or depending on the current signal propagation condition and/or depending on the property of the user equipment; and
wherein the user equipment is configured to apply said one of the one or more updated configurations or to apply one of the one or more newly generated configurations at the user equipment.

86. A user equipment according to claim 60,
wherein the two or more configurations depend on environment information and/or depending on properties information and/or depending on capabilities information and/or depending on Life Cycle Management information,
wherein the environment information depends on a current environment where the user equipment is currently located,
wherein the properties information indicates on one or more current properties of the user equipment,
wherein the capabilities information indicates one or more general or current capabilities of the user equipment,
wherein the Life Cycle Management information indicates information on Life Cycle Management of the user equipment.

87. A user equipment according to claim 60,
wherein the user equipment is configured to receive the two or more configurations together with side information which supports to determine under which circumstances which of the two or more configurations is applicable; and
wherein the user equipment is configured to select said one of the two or more configurations depending on the side information.

88. A user equipment according to claim 60,
wherein the two or more configurations are applicable for different channel states depending on line-of-sight conditions of the user equipment to one or more base stations, and/or are applicable for different transmission and/or reception qualities, and/or are applicable for different battery states of the user equipment.

89. A user equipment according to claim 60,
wherein the two or more configurations are applicable for different measurement properties.

90. A user equipment according to claim 89,
wherein the two or more configurations are applicable for different power related average powers, such as RSRP and/or SINR, and/or are applicable for different path powers, such RSRPP, and/or are applicable for different timings (ToA), and/or are applicable for different timing differences between two or more resources, and/or are applicable for different angular or directional information.

91. A user equipment according to claim 60,
wherein one of the two or more configurations comprises a default configuration or a fallback configuration, which is applicable by default, if none of all other configurations of the two or more configurations is applicable.

92. A user equipment according to claim 60,
wherein the two or more configurations comprise two or more measurement configurations.

93. A user equipment according to claim 92,
wherein at least one of the two or more measurement configurations is applicable for a DL or SL resource measurement at a TRP.

94. A user equipment according to claim 92,
wherein at least one of the two or more measurement configurations comprises certainty information or potential relevant or detectable resources; and/or
wherein at least one of the two or more measurement configurations comprises information to enable the other device to derive necessary/desired information, e.g., detection threshold information, resources group association; and/or
wherein at least one of the two or more measurement configurations comprises measurement procedures, which instruct or assist the device identify a set of relevant resources, e.g., depending on one or more initial measurements.

95. A user equipment according to claim 60,
wherein the two or more configurations comprise two or more report configurations.

96. A user equipment according to claim 95,
wherein at least one of the two or more report configurations is applicable for a DL or SL resource derived from a channel measurement at a UE or an UL derived from a channel measurement at a TRP.

97. A user equipment according to claim 95,
wherein at least one of the two or more report configurations is dependent on the environment and measurement characteristics, wherein the UE/TRP selects the dynamic configuration based on a given event, and/or
wherein at least one of the two or more report configurations is applicable at the inference device where the AI/ML inference model is installed or to a device or monitoring information to as second entity/device which can be a network entity or in the case of two or multiple sided AI/ML models.

98. A user equipment according to claim 60,
wherein the two or more configurations comprise two or more transmission configurations.

99. A user equipment according to claim 98,
wherein at least one of the two or more transmission configurations is applicable for UL at a UE or for DL resources at a TRP.

100. A user equipment according to claim 98,
wherein at least one of the two or more transmission configurations depends on a QoS and/or depends on particular environmental conditions and/or depends on characteristics of a received signal.

101. A user equipment according to claim 98,
wherein at least one of the two or more transmission configurations comprise at least one of
a time resource allocation and a frequency resource allocation,
a power control configuration,
a spatial relation.

102. A user equipment according to claim 60,
wherein the two or more configurations comprise two or more operation configurations.

103. A user equipment according to claim 102,
wherein at least one of the two or more operational configurations is a user-performed procedural configuration comprising a series of steps or procedures that users must follow to adjust a behaviour or one or more properties of a system.

104. A user equipment according to claim 60,
wherein at least one of the two or more configurations depends on one or more performance targets, which comprise one or more of the following:
a positioning accuracy,
a data rate,
a throughput/a data rata,
a latency,
a QoS KPI,
a SINR,
a transmit power.

105. A user equipment according to claim 60,
wherein at least one of the two or more configurations depends on one or more constraints, which comprise one or more of the following:
time/frequency resources,
a number of available TRPs,
an energy level of the user equipment,
e.g., a battery status of the user equipment, or
e.g., an operation mode (for example, low power with more often sleep phases),
a power operation mode of the user equipment.

106. A user equipment according to claim 60,
wherein at least one of the two or more configurations depends on one or more capabilities of the user equipment.

107. A user equipment according to claim 60,
wherein at least one of the two or more configurations depends on one or more environmental properties, which comprise one or more of the following:
a geographical area of the user equipment,
an area ID,
a timing information,
a positioning estimate.

108. A user equipment according to claim 60,
wherein at least one of the two or more configurations depends on one or more Life Cycle Management model requirements.

109. A user equipment according to claim 60,
wherein, for generating the two or more configurations, the user equipment is configured to provide information to the network entity which comprises one or more of the following:
one or more required resources, and/or
a set of initial measurements/report, and/or
capabilities and/or supported functionalities of the user equipment.

110. A network client, wherein the network client is configured for
transmitting information on a target or transmit a request to network entity of a wireless communication system, wherein a reception of the information on the target or a reception of the request by the network entity causes the network entity to generate two or more configurations for another device of the wireless communication system.

111. A network client according to claim 110,
wherein a reception of the information on the target or a reception of the request by the network entity causes the network entity to generate two or more configurations depending on the target or depending on the request.

112. A network client according to claim 111,
wherein the target comprises a performance target, and/or
wherein the target comprises a quality-of service, and/or
wherein the request comprises a request for a service.

113. A network client according to claim 112,
wherein the network client is configured to repeatedly transmit requests to the network entity and/or to repeatedly transmit the information on the target to the network entity.

114. A network client according to claim 110,
wherein the two or more configurations are generated using an artificial intelligence/machine-learning model.

115. A network client according to claim 114,
wherein the two or more configurations are generated using the artificial intelligence/machine-learning model depending on the target or the request.

116. A wireless communication system comprising:
a network entity according to claim 1, and
a user equipment according to claim 60.

117. A wireless communication system according to claim 116,
wherein the wireless communication system further comprises a network client according to claim 110.

118. A wireless communication system comprising:
a network entity according to claim 1, and
a network client according to claim 110.

119. A method for a wireless communication system, wherein the method comprises:
generating, by a network entity of the wireless communication system, two or more configurations for another device of the wireless communication system, wherein the two or more configurations differ in at least one parameter; and
transmitting, by the network entity, the two or more configurations to another entity of the wireless communication system, for example, to a user equipment or, for example, to a base station,
wherein the two or more configurations are applicable for different environments of the other device and/or for different states of the other device and/or for different signal propagation conditions and/or for different properties of the other device.

120. A method for a wireless communication system, wherein the method comprises:
receiving a target (e.g., a performance target),
requesting and/or receiving information and/or identifying configurations for necessary resources and/or measurement and/or reporting depending on the target,
determining at least one resource and/or measurement and/or report configuration to achieve the target,
enabling or activating an artificial intelligence/machine-learning model using the configured resources and using received reporting to perform a task (e.g., beam management or positioning);
and/or
receiving, by a network entity of the wireless communication system, a constraint limit on one or more available resources,
predicting, by the network entity, a maximum performance (e.g., positioning accuracy) that is achievable,
selecting and configuring, by the network entity, resources, and/or selecting a reporting complexity to achieve the maximum performance,
enabling or activating, by the network entity, an artificial intelligence/machine-learning model using the configured resources and using a received reporting to perform a task (e.g., to predict a position of a UE).

121. A method for a wireless communication system, wherein the method comprises:
receiving, by a user equipment of the wireless communication system from a network entity of the wireless communication system, two or more configurations, wherein the two or more configurations differ in at least one parameter; wherein the two or more configurations are applicable for different environments of the user equipment and/or for different states of the user equipment and/or for different signal propagation conditions and/or for different properties of the user equipment, selecting, by the user equipment, one of the two or more configurations depending on a current environment of the user equipment and/or depending on a current state of the user equipment and/or depending on a current signal propagation condition and/or depending on a property of the user equipment; and
applying, by the user equipment, said one of the two or more configurations at the user equipment, for example for transmitting or receiving a reference signal and/or for measuring and/or reporting on a reference signal.

122. A method for a wireless communication system, wherein the method comprises:
selecting, by a user equipment, one of two or more configurations depending on a current environment of the user equipment and/or depending on a current state of the user equipment and/or depending on a current different signal propagation condition depending on a property of the user equipment; wherein the two or more configurations differ in at least one parameter; wherein the two or more configurations are applicable for different environments of the user equipment and/or for different states of the user equipment and/or for different properties of the user equipment; and
applying, by the user equipment, said one of the two or more configurations at the user equipment, for example for transmitting or receiving a reference signal and/or for measuring and/or reporting on a reference signal;
wherein the user equipment selects and applies said one of the two or more configurations for machine-learning data collection and/or for machine-learning model monitoring.

123. A method for a wireless communication system, wherein the method comprises:
transmitting, by a network client, information on a target or transmit a request to network entity of a wireless communication system, wherein a reception of the information on the target or a reception of the request by the network entity causes the network entity to generate two or more configurations for another device of the wireless communication system.

124. A non-transitory digital storage medium having a computer program stored thereon to perform the method of claim 119 when said computer program is run by a computer.

125. A non-transitory digital storage medium having a computer program stored thereon to perform the method of claim 120 when said computer program is run by a computer.

126. A non-transitory digital storage medium having a computer program stored thereon to perform the method of claim 121 when said computer program is run by a computer.

127. A non-transitory digital storage medium having a computer program stored thereon to perform the method of claim 122 when said computer program is run by a computer.

128. A non-transitory digital storage medium having a computer program stored thereon to perform the method of claim 123 when said computer program is run by a computer.
